(19) United States
(12) Patent Application Publication
(10) Pub. No.: US 2014/0045036 A1
(43) Pub. Date: Feb. 13, 2014

(54) CONVERTER CELL COMPRISING A CELL HOUSING, A BATTERY WITH AT LEAST TWO SUCH CONVERTER CELLS AND A METHOD OF MANUFACTURING A CONVERTER CELL

(71) Applicant: Li-Tec Battery GmbH, Kamenz (DE)

(72) Inventor: Tim Schaefer, Harztor (DE)

(73) Assignee: Li-Tec Battery GmbH, Kamenz (DE)

(21) Appl. No.: 13/966,039

(22) Filed: Aug. 13, 2013

Related U.S. Application Data
(60) Provisional application No. 61/682,363, filed on Aug. 13, 2012.

(30) Foreign Application Priority Data
Aug. 13, 2012 (DE) 10 2012 016 022.4

(51) Int. Cl. H01M 2/20

(52) U.S. Cl. CPC H01M 2/206
USPC 429/156; 429/186; 29/623.1

(57) ABSTRACT

A converter cell (1)

comprising at least one particularly rechargeable electrode assembly (2) provided to at least intermittently supply electrical energy, particularly to a load, which exhibits at least two electrodes (3, 3a) of different polarity,
comprising at least one current conducting device (4, 4a) provided to electrically connect, preferably materially, to one of the electrodes (3, 3a) of the electrode assembly (2),
having a cell housing (5) comprising a first housing part (6), wherein the first housing part (6) is provided to enclose at least areas of the electrode assembly (2).

### CROSS-REFERENCE TO RELATED APPLICATIONS

This application claims the benefit of U.S. Provisional Patent Application Ser. No. 61/682,363, filed on Aug. 13, 2012, which is incorporated herein by reference in its entirety. This application also claims priority to German Patent Application 10 2012 016 022.4, filed Aug. 13, 2012, which is incorporated herein by reference in its entirety.

### DESCRIPTION

The present invention relates to a converter cell, in particular designed as an electrochemical energy converting device, having a cell housing, a battery having at least two such electrochemical energy converting devices and a method of manufacturing an electrochemical energy converting device. The invention is described in conjunction with lithium ion batteries for supplying motor vehicle drives. It is pointed out that the invention can also be used independently of the chemistry of the converter cell, the type of battery or the type of drive being supplied.

Batteries comprising a plurality of converter cells for supplying motor vehicle drives are known in the prior art. Conventional converter cells comprise an electrode assembly having at least two electrodes of different polarity and a separator. The separator separates and/or distances the electrodes of different polarity. Conventional converter cells further comprise a cell housing which encloses at least areas of the electrode assembly. Conventional converter cells further comprise at least two current conducting devices each electrically connected to a respective electrode of the electrode assembly.

The high expenditure required in manufacturing converter cells of such design is at times regarded as problematic.

It is an object of the invention to provide a converter cell which can be manufactured at lower expenditure and/or costs.

This object is accomplished by a converter call in accordance with claim 1. Claim 10 describes a battery having at least two such inventive converter cells. Said object is also accomplished by a manufacturing method for a converter cell in accordance with claim 11. Preferred embodiments of the invention constitute the subject matter of the subclaims.

A converter cell according to the invention, particularly one designed as an electrochemical energy conduction device, comprises at least one, particularly rechargeable, electrode assembly. The at least one electrode assembly is provided to at least intermittently supply electrical energy to an electrical load. The electrode assembly exhibits at least two electrodes of different polarity. The converter cell exhibits one, two or more current conducting devices, wherein at least one or more of said current conducting devices are provided to be electrically connected to one of the electrodes of the electrode assembly, preferably in a material connection. The converter cell exhibits a cell housing having at least one particularly first housing part, wherein the cell housing is provided to enclose at least areas of the electrode assembly. The first housing part comprises at least one functional device provided to support the release of energy from the electrode assembly, particularly to an electrical load. The functional device is operatively connected to the electrode assembly, particularly for receiving energy. The first housing part comprises at least one first support element which is provided to define the border between the at least one functional device and the environment of the converter cell. The first support element serves in particular in supporting the at least one functional device; i.e. particularly to counteract unwanted relative displacement of the at least one functional device relative the converter cell. The first support element serves in particular in protecting the at least one functional device from damaging environmental effects. The first support element is formed with a metal sheet.

The at least one electrode assembly is preferably designed to at least intermittently convert chemical energy into electrical energy. The at least one electrode assembly is preferably provided to at least intermittently convert particularly supplied electrical energy into chemical energy.

The first support element can preferably be electrically insulated vis-à-vis at least one of the functional devices and/or at least one of the current conducting devices, particularly by means of a first polymer material.

### Mode of Operation

With the inventive design of the first housing part, the functional device assumes a plurality of functions which are performed by separate components in conventionally designed converter cells, particularly those related to the converter cell and/or electrode assembly operation. A plurality of separate components and/or functional elements are centralized in the at least one functional device, particular-ly as its own separate functional assembly. Hence, fewer assemblies are required to manufacture the inventive converter cell, whereby the manufacturing and/or assembling expenditure is reduced. Doing so thus achieves the underlying object.

The inventive converter cell further provides the advantage of increasing durability by the first support element of the underlying functional device protecting against mechanical damage, particularly from a foreign body acting on the cell housing.

The inventive converter cell further provides the advantage of increasing durability by the first support element improving the cohesion of the functional device particularly upon accelerations or vibrations occurring during the operation of the converter cell.

### Definitions and Preferred Configurations

To be understood by an electrode assembly in the sense of the invention is a device which in particular serves in the supplying of electrical energy. The electrode assembly comprises at least two electrodes of different polarity. Said electrodes of different polarity are spaced apart by a separator, wherein the separator is conductive to ions but not to electrons. The electrode assembly is preferably of substantially rectangular parallelepipedal configuration. The electrode assembly is preferably connected, particularly in a material connection, to two of said current conducting devices of differing polarity which serve the at least indirect electrical connection to at least one neighboring electrode assembly and/or at least the indirect electrical connection to the electrical load.

At least one of said electrodes preferably exhibits a particularly metallic collector film as well as an active mass. The active mass is applied to at least one side of the collector film. When the electrode assembly is charged or discharged, electrons are exchanged between the collector film and the active mass. At least one collector tab is preferably connected to the collector film, particularly in a material connection. Particularly preferential is for a plurality of collector tabs to be connected to the collector film, particularly in a material connection. This configuration provides the advantage of reducing the current of each respective collector tab.

At least one of said electrodes preferably exhibits a particularly metallic collector film as well as two active masses of differing polarity which are arranged on different areas of the collector film and spaced apart by said collector film. The term “bi-cell” is also commonly used for such an arrangement of active masses. When the electrode assembly is charged or discharged, electrons are exchanged between the collector film and the active mass. At least one collector tab is preferably connected to the collector film, particularly in a material connection.

Particularly preferential is for a plurality of collector tabs to be connected to the collector film, particularly in a material connection. This configuration provides the advantage of reducing the number of electrons flowing through a collector tab per respective unit of time.

Two electrodes of different polarity are spaced apart in the electrode assembly by a separator. The separator is permeable to ions but not to electrons. The separator preferably contains at least a part of the electrolyte and/or the conducting salt. The electrolyte is preferably designed to be substantially without a liquid component, particularly after the converter cell is sealed. The conducting salt preferably comprises lithium. Particularly preferential is for lithium ions to be stored and/or intercalated in the negative electrode during charging and released again upon discharging.

The electrode assembly is preferably designed to convert supplied electrical energy into chemical energy and to store it as chemical energy. The electrode assembly is preferably designed to convert in particular stored chemical energy into electrical energy prior to the electrode assembly providing said electrical energy to an electrical load. This is then also referred to as a rechargeable electrode assembly. Particularly preferential is for lithium ions to be stored and/or intercalated in the negative electrode during charging and released again upon discharging.

In accordance with a first preferred configuration, the electrode assembly is configured as an electrode coil, particularly a substantially cylindrical electrode coil. Said electrode coil is preferably rechargeable. This design provides the advantage of simplifying the manufacture particularly in being able to work with band-shaped electrodes. This design provides the advantage of being able to easily increase the charging capacity, indicated for example in ampere-hours [Ah] or watt-hours [Wh], less frequently in coulombs [C], by means of further windings. The electrode assembly is preferably designed as a flat-pack type electrode coil. This design provides the advantage of being able to arrange same next to a further flat-pack type electrode coil in space-saving manner, particularly within a battery.

In accordance with a further preferred configuration, the electrode assembly is configured as a substantially rectangular parallelepipedal electrode stack. Said electrode assembly is preferably rechargeable. The electrode assembly comprises a predetermined succession of stack plates, whereby two respective electrode plates of different polarity are separated by a separator plate. Each electrode plate is preferably connected to a current conducting device, particularly in material connection, particularly preferentially formed integrally with the current conducting device. Electrode plates of the same polarity are preferably electrically interconnected, particularly by means of a common current conducting device. This design to the electrode assembly provides the advantage of being able to easily increase the charging capacity, indicated for example in ampere-hours [Ah] or watt-hours [Wh], less frequently in coulombs [C], by adding further electrode plates. It is particularly preferential for at least two separator plates to be connected to one another and enclose a boundary edge of an electrode sheet. Such an electrode assembly having a single, particularly sinuous, separator is described in WO 2011/020545. This design provides the advantage of being able to counter a parasitic current originating from said boundary edge to an electrode plate of different polarity.

In accordance with a third preferred configuration, the electrode assembly is designed to supply electrical energy while being continuously fed at least one fuel and one oxidizing agent, hereinafter referred to as process fluids, the chemical reaction of which produces an educt, particularly supported by at least one catalyst, and the discharging of said educt. The electrode assembly according to this preferred configuration is also referred to as a converter assembly in the following.

The converter assembly is designed as a substantially rectangular parallelepipedal electrode stack and comprises at least two, particularly plate-like electrodes of different polarity. At least the first electrode is preferably at least partially coated with a catalyst. The electrodes are spaced apart, preferably by a separator and/or membrane which is permeable to ions, but not to electrons. The energy converter further comprises two fluid control devices respectively arranged adjacent to the electrodes of different polarity and provided to supply the process fluids to the electrodes. Preferably at least one of the fluid control devices is provided to discharge the educt. The converter assembly comprises at least one of the following: fluid control device for the fuel—electrode of first polarity—membrane—electrode of second polarity—fluid control device for the oxidizing agent, particularly also for the educt. A plurality of these sequences are preferably connected in series for increased electrical voltage.

When the energy converter is in operation, the fuel is supplied to the first electrode, particularly as a fluid flow through channels of the first fluid control device. The fuel is ionized at the first electrode by releasing electrons. The electrons are conducted via the first electrode, particularly via one of the current conducting devices, particularly in the direction of an electrical load or an adjacent converter cell. The ionized fuel travels through the ion-permeable membrane to the second electrode. The oxidizing agent is supplied to the second electrode, particularly as a fluid flow through channels of the second fluid control device. Coming together at the second electrode: the oxidizing agent, the ionized fuel as well as electrons of the electrical load or an adjacent converter cell. The chemical reaction to educt occurs at the second electrode, which is preferably conducted through channels of the second fluid control device.

A current conducting device in the sense of the invention is to be understood as a device which particularly serves in conducting electrons between one of the electrodes of the electrode assembly and an load or between one of the electrodes and an adjacent converter cell. To this end, the current conducting device is electrically connected, preferably in a material connection, to one of the electrodes of the electrode assembly. The current conducting device is preferably at least indirectly connected to one of the loads to be supplied.

The current conducting device comprises an electrically conductive region having a metallic material, preferably aluminum and/or copper, particularly preferentially partially coated with nickel. This design provides the advantage of reduced contact resistance. The current conducting device is preferably of solid metallic material configuration. The material of the current conducting device is preferably consistent with the material of the collector film of the electrode to which the current conducting device is connected, particularly in a material connection. This design provides the advantage of reduced contact corrosion between the current conducting device and the collector film.

The current conducting device comprises a second region arranged within the converter cell. This second region is electrically connected to at least one electrode of the electrode assembly, and preferably to all the electrodes of the same polarity, preferably in a material connection.

The second region preferably comprises at least one collector tab. This collector tab is connected to one of the electrodes of the electrode assembly, particularly to its collector film, particularly in a material connection. The collector tab is designed as an electrically conductive strip or foil, preferably a metal foil. This design provides the advantage of being able to compensate displacement between a symmetrical plane through the region of the current conducting device extending in the area of the conductor cell and a plane through said electrode or collector film. Particularly preferential is for the second region to comprise a plurality of collector tabs. The collector tabs provide multiple current paths to the same electrode, thereby advantageously reducing the current density of the current path, or to different electrodes of the same polarity of the electrode stack, thereby forming a parallel connection of the electrodes of like polarity.

The current conducting device preferably also comprises a first region which extends into the area of the converter cell. The first region is at least indirectly electrically connected to one of the loads to be supplied or a second, particularly adjacent, converter cell, preferably by means of a connector device which is not a part of the converter cell, whereby a bus bar, a conductor lead or a connection cable is also viable as a connector device as defined by the invention. In accordance with one preferred configuration, the first region is configured as a metal plate or a plate having a metallic coating. This design has the advantage of providing a mechanically stable, substantially flat surface for establishing a lone and/or as continuous as possible electrical connection to a connector device.

The current conducting device preferably comprises a substantially plate-shaped, metallic or metal-coated current collector. The current collector is connected to particularly all the collector tabs of like polarity in the second region of the current conducting device, particularly in a material connection. The material of the current collector is preferably consistent with the material of the collector tab. This design provides the advantage of being able to configure a more mechanically stable current collector for connecting to a connector device and/or one of the housing parts than a foil-like collector tab could be configured. This thus improves the converter cell's durability. This design further provides the advantage of the current collector being able to be connected to the cell housing before the electrode assembly with its affixed collector tabs is introduced into the cell housing.

A cell housing in the sense of the invention is to be understood as a device which in particular
serves in delimiting the electrode assembly relative the environment,
serves in protecting the electrode assembly from harmful environmental influences, particularly protecting against water from the environment,
hinders substances from leaking out of the electrode assembly into the environment,
preferably encloses the electrode assembly in substantially gas-tight manner.

The cell housing at least partially, and preferentially substantially completely, encloses the electrode assembly. The cell housing is thereby adapted to the shape of the electrode assembly. The cell housing, just like the electrode assembly, is preferably of substantially rectangular parallelepipedal configuration. The cell housing preferably encloses the electrode assembly such that at least one wall of the cell housing exerts a force on the electrode assembly, wherein the force counters an unwanted relative motion of the electrode assembly relative to said cell housing. Particularly preferential is for the cell housing to receive the electrode assembly in form-fit and/or force-fit manner. The cell housing is preferably electrically insulated vis-à-vis the environment. The cell housing is preferably electrically insulated vis-à-vis the electrode assembly.

The cell housing is configured with at least one substantially rigid first housing part. The first housing part comprises at least one functional device which supports the release of energy from the electrode assembly, particularly to a load. The first housing part comprises a first support element which retains the at least one functional device relative the environment of the converter cell. The first housing part in particular serves in limiting the electrode assembly relative the environment of the converter cell as well as in protecting the electrode assembly. The first housing part in particular serves in protecting the electrode assembly. The first housing part preferably exhibits a wall thickness of at least 0.3 mm. The material and geometry of the first housing part is preferably selected such that its flexural rigidity stands up to the operational demands.

A functional device in the sense of the invention refers to a device which particularly serves in supporting the smooth operation of the electrode assembly. The functional device is operatively connected to the electrode assembly. An operatively connected functional device and electrode assembly in the sense of the invention means that particularly energy, an electric potential, material and/or information, in particular related to the electrode assembly's operational parameters, can be exchanged between the functional device and the electrode assembly. The at least one functional device preferably comprises at least one electrically conductive region. The at least one functional device preferably comprises at least one electrically insulating region which particularly preferentially serves as a base for functional elements. The functional device is preferably connected to the first support element, particularly in a material connection. The first support element essentially completely shields the functional device from the environment, provided the first support element does not comprise any pole contact openings.

The functional device is preferably electrically connected to at least one of the electrodes, particularly preferentially to at least two electrodes of different polarity. This design provides the advantage of the functional device having the electric potential of the connected electrode, in particular can be supplied with energy from the electrode assembly.

The functional device is preferably configured as a diffusion barrier which addresses the exchange of gas between the environment of the converter cell and the interior of the cell housing.

The functional device is preferably configured with a circuit carrier, particularly preferentially with a populated and/or printed, particularly flexible, circuit board. This configuration provides the advantage of the circuit board being protected by the first support element. This configuration provides the advantage of the functional device remaining on the converter cell when the converter cell is extracted from a battery.

To be understood by a first support element in the sense of the invention is a device which is provided to retain at least some areas of the at least one functional device. The first support element is faced toward the environment of the converter cell. Within the meaning of the invention, “retain” is to be understood as countering an unwanted relative movement of the at least one functional element relative the first support element or the converter cell respectively. The first support element serves in particular to counter an unwanted relative displacement of the at least one functional device relative the first support element or the converter cell respectively. The first support element serves in particular to protect the at least one functional device particularly against damaging influences from the environment of the converter cell. Thus, this design provides the advantage of protecting the electrode assembly from a foreign body acting upon or even penetrating into the cell housing, in particular without requiring a separate protective device.

The first support element is formed with a metal, preferably aluminum, copper, iron or an alloy having at least one of said metals. The first support element is preferably configured as a metal sheet.

The at least one functional device is preferably connected to preferably the first support element, particularly in a material connection, particularly bonded.

The first support element is preferably configured as a flat, first base layer. This design provides the advantage of the first support element supporting the at least one functional device along a larger surface area, thereby particularly improving the integrity of the at least one functional device. This design provides the advantage of also improving the protection of the electrode assembly.

The first support element preferably comprises one or two pole contact openings, each making a region of the adjacent functional device accessible, particularly electrically, from the environment of the converter cell.

The following will describe advantageous designs and preferred embodiments of the inventive converter cell as well as its advantages.

The inventive converter cell preferably comprises at least two electrode assemblies in accordance with their first or second preferred configuration which are connected in series in the cell housing. This design provides the advantage of increasing the electrical voltage able to be provided by the converter cell, particularly the terminal voltage of the converter cell.

The at least one functional device preferably comprises at least one or more functional elements.

To be understood by a functional element in the sense of the invention is an element which particularly serves in supporting the smooth operation of the electrode assembly. The functional element in particular serves
the electrical connection of the electrode assembly to the environment of the converter cell, and/or
the particularly electrical connection of the at least one or more of said functional devices to the electrode assembly, and/or
in supplying energy particularly from the electrode assembly to at least one or more of said functional devices, and/or
in influencing and/or limiting the electric current flowing into the electrode assembly or withdrawn from the electrode assembly, and/or
in the control of the converter cell and/or electrode assembly, and/or
in the detecting of converter cell operating parameters, particularly operating parameters of the electrode assembly, and/or
in the exchange of thermal energy with the electrode assembly, preferably the dissipating of heat from the electrode assembly, and/or
in the input or output of a chemical substance fluid flow, and/or
in the detecting of the converter cell's safety state, the defect analysis, the detecting/notifying of status, and/or
in communicating with the environment, particularly with a battery control unit or an independent control.

At least one or more of said functional elements is preferably designed as
a pole contact section accessible from the environment of the converter cell, particularly through a pole contact opening of the first support element, which is in particular arranged on an outer surface of the cell housing, wherein the pole contact section exhibits the electric potential of one of the electrodes of the electrode assembly, wherein this design provides the advantage of at least one of said current conducting devices being able to be configured without a first region,
an electrode connecting section which serves the electrical connection of the functional device to the electrode assembly, particularly serving the supplying of the functional device, particularly serving the electrical connection to one of the current conducting devices of the converter cell,
a sensor, detecting element, voltage sensor, current sensor, temperature sensor or thermocouple respectively, pressure sensor, chemical substance sensor, hereinafter referred to as “material sensor”, gas sensor, liquid sensor, position sensor or acceleration sensor, wherein the sensors and/or detectors in particular serve in detecting converter cell operating parameters, particularly of the electrode assembly,
a control device, in particular a cell control device, an application-specific integrated circuit, microprocessor or data storage device particularly serving in the control of the converter cell, its electrode assembly respectively,
a regulating device, pressure relief device actuator, switching device, semiconductor switch, discharge resistor, current limiter or interrupter particularly serving in realizing corrective actions to be taken to detected, particularly unwanted, converter cell operating states which particularly serve in the influencing or limiting of the electrical current into or out of the electrode assembly,
a conductive path serving the electrical interconnection of at least two or more of the functional elements,
a recess which enables connecting bodies spaced apart by the functional device or which enables a body to extend through the functional device,
a heat exchange region serving the exchange of thermal energy with the electrode assembly,
a fluid passage serving an exchange of a chemical substance with the electrode assembly, or as
a communication device, beeper, light-emitting diode, infrared interface, GPS device, GSM module, first short-range radio device or transponder which serves in the communication particularly with a battery control unit or an independent control, serving in the transmitting of data, particularly to a battery control unit or an independent control, serving particularly the displaying of an in particular predetermined operating state of the converter cell or the electrode assembly respectively.

The first short-range radio device is preferably provided to intermittently send a predetermined second signal, particularly on demand or upon a predetermined first signal from a second short-range radio device, wherein the second short-range radio device is connected to the battery control unit by means of signals. It is particularly preferential for the first short-range device to send an identifier for the converter cell simultaneously with the predetermined second signal.

A plurality of functional elements preferably works together for the smooth operation of the electrode assembly. Said functional elements are particularly preferentially interconnected electrically.

A first preferred configuration of the functional device comprises as functional elements at least:
one of said current sensors for measuring the electric current input to the electrode assembly or output from the electrode assembly, hereinafter also referred to as the cell current,
one of said voltage sensors for measuring the electrical voltage of the electrode assembly, particularly the terminal voltage,
one of said thermocouples for measuring the temperature of the electrode assembly or one of said current conducting devices,
one of said cell control devices for processing signals of the in particular above-cited sensors,
one, preferably two, of said electrode connecting sections electrically connected to one, preferably two, said electrodes of particularly different polarity, which preferably serve in supplying electrical energy to the cell control device and/or at least one of said sensors,
at least two or more of said conductive paths for electrically connecting the remaining functional elements of said functional device,
preferably at least one or more of said switching devices, said current interrupters and/or said current limiters,
preferably a data storage device which serves in the storing and/or furnishing of data and/or calculation rules,
preferably a first short-range radio device which serves in exchanging data with a battery control unit or its second short-range radio device respectively,
preferably two cell control connections which serve in connecting to a data bus of a controlling battery serving to exchange data with a battery control unit.
preferably two heat exchange regions which serve in the exchange of thermal energy with the electrode assembly and a heat exchanger which is not a part of the converter cell.

This preferential configuration of the functional device provides the advantage of the functional device being able to be used for controlling or monitoring the electrode assembly. This configuration provides the advantage of the functional device remaining on the converter cell upon the converter cell being extracted from the battery.

In accordance with a first preferred further development of this preferred configu-ration, the functional device is designed with a circuit board populated with said functional elements and comprising conductive paths for the connection of the remaining functional elements. This preferred further development provides the advantage of the circuit board being able to be introduced or fit onto said first support element at little expenditure during the manufacture of the first housing part. This preferred further development provides the advantage of the circuit board remaining on the converter cell upon the converter cell being extracted from the battery.

In accordance with a further preferred further development of this preferred configuration, the functional device is designed with a flexible foil, particularly of polyimide or Kapton® populated with said functional elements and comprising conductive paths for the connection of the remaining functional elements. This preferred further development provides the advantage of the functional device being able to be introduced or fit onto said first support element at little expenditure during the manufacture of the first housing part. This preferred further development provides the advantage of the functional device remaining on the converter cell upon the converter cell being extracted from the battery.

In accordance with a preferred design, the converter cell, or its cell housing respectively, comprises a second housing part.

A second housing part in the sense of the invention is to be understood as a device which is particularly provided to be at least in part connected or connectable, particularly in a material connection, to the first housing part, particularly at least indirectly. The second housing part is provided to form the cell housing of the converter cell together with the first housing part. The first housing part and the second housing part together preferably substantially fully enclose the electrode assembly and counter in particular an exchange of substances between the electrode assembly and the environment of the converter cell. The second housing part preferably comprises at least one first support element which particularly preferentially corresponds substantially to the first support element of the first housing part. The second housing part preferably comprises at least one of said functional devices. Particularly preferential is for the second housing part to be of identical configuration to the first housing part. This design provides the advantage of reducing production and storage costs.

In one first preferred embodiment of the cell housing, the first housing part and the second housing part are connected together via a hinge section. The hinge section extends along a respective edge of the first housing part and the second housing part. The hinge section preferably exhibits a lesser wall thickness than the areas of the housing parts which limit the electrode assembly. This embodiment provides the advantage of reducing the length of the edges of the in particular rectangular parallelepipedal cell housing needing to be sealed.

In a second preferred embodiment of the cell housing, the first housing part and the second housing part are distanced from one another by a frame. The housing parts are connected to the frame, particularly in a material connection. The frame essentially comprises four frame elements which are arranged relative one another into a rectangle. The frame limits an area in which the electrode assembly can be at least partially accommodated. A converter cell without functional devices having a cell housing formed from a frame is also termed a flat-cell frame. The frame is preferably formed with the second polymer material, particularly preferentially completely of the second polymer material. This preferred embodiment provides the advantage of being able to form each housing part without a receiving space. In accordance with a preferred further development, two of said current conducting devices extend at least partially through the frame into the environment. In accordance with a further preferred further development, at least one of said housing parts comprises one or two said pole contact sections.

In accordance with a preferred configuration, the first housing part and/or the second housing part comprises a receiving space able to at least partially accommodate the electrode assembly.

Said receiving space is preferably dimensioned such that there is frictional force between at least one inner surface of the cell housing and a surface area of the electrode assembly after closing the housing parts around the electrode assembly into a cell housing. This frictional force can counter an unwanted relative movement of the cell housing and electrode assembly.

In accordance with one preferred configuration, the receiving spaces of the first housing part and the second housing part are of identical configuration. In this preferred design, each housing part accommodates a respective half of the electrode assembly. This design provides the advantage of reducing manufacturing and storage costs.

In accordance with a further preferred configuration, the first or the second housing part accommodates the electrode assembly substantially completely. The first or the second housing part is preferably configured as a bowl. The electrode assembly is disposed in the interior of the bowl, wherein the interior corresponds to the receiving space. At least one functional device is disposed in the multi-layer wall of the bowl. In the present preferred configuration, the other housing part is essentially configured as a flat cover, without a receiving space and/or functional device, so as to close the first housing part. This design provides the advantage of being able to form the second housing part more economically. In accordance with a preferred further development, two of said current conducting devices extend at least partially through the wall of the bowl or through the wall of the cover into the environment. In accordance with a further preferred development, the cover or the bowl comprises two of said pole contact sections.

The first and/or the second housing part preferably comprises a separator element disposed between at least one of said functional devices and electrode assembly.

To be understood by a separator element in the terms of the invention is a device which is provided to counter an in particular unwanted chemical interaction between the functional device and the electrode assembly. The second separator element is preferably configured as a second separating layer. The separator element comprises a particularly fiber-interspersed first polymer material, preferably a thermoplastic. The softening point is preferably higher than the converter cell's operating temperature range, particularly preferentially around at least 10 K. The separator element further comprises a fiber material, preferably glass fibers, carbon fibers, basalt fibers and/or aramide fibers, which in particular serve in reinforcing the separator element. The fiber material is preferably configured particularly as a textile fabric or scrim and particularly preferentially substantially fully encased by the first polymer material. This design provides the further advantage of the separator element being able to separate the at least one functional device from the substances of the electrode assembly.

It is particularly preferential for the separator element to be connected, particularly materially, to the at least one functional device. This design provides the advantage of being able to address an unwanted relative motion of the separator element and the functional device.

It is particularly preferential for the separator element to exhibit at least one recess which enables a sensor of the functional device to make direct contact with the electrode assembly for the purpose of substance detection. This design provides the advantage of hydrogen fluoride, hereinafter also referred to as HF, being able to be present at a lower time constant.

It is particularly preferential for the separator element to comprise at least one contact opening, particularly in an edge section of the housing part, which in particular serves the electrical connection of the functional device adjacent the separator element to one of the current conducting devices of the converter cell. This design provides the advantage of the functional device having the electric potential of one of the electrodes of the electrode assembly. This design provides the further advantage of the electrode assembly being able to supply energy to the functional device.

The first and/or the second housing part preferably comprises a second polymer material in an edge section. The second polymer material serves in particular the material connection to another of the other housing parts, particularly preferentially the material connection of the first housing part to the second housing part. The softening point of the second polymer material is preferably higher than the converter cell's operating temperature range, particularly preferentially around at least 10 K. This design provides the advantage of improving the long-term sealing of the cell housing interior.

The second polymer material is preferably of thermoplastic configuration, particularly having a softening point higher than the converter cell's operating temperature range. This design provides the advantage of simplifying the feeding of the second polymer material into a machining device, particularly a forming tool. This design provides the further advantage of a close-fitting, particularly gas-tight connection of the second polymer material to the respective housing part.

The second polymer material preferably corresponds to the first polymer material. This design provides the further advantage of a close-fitting, particularly gas-tight connection of the second polymer material to the first polymer material.

In accordance with a first preferred configuration, the second polymer material encloses an edge section of the first and/or second housing part. This preferred configuration provides the advantage of a close-fitting, particularly gas-tight connection of the second polymer material to the respective housing part.

In accordance with a second preferred configuration, the second polymer material is formed into a frame. The housing parts are connected to the frame, particularly in a material connection. The frame essentially exhibits four frame elements which are arranged relative one another into a rectangle. The frame defines a space in which the electrode assembly can be at least partially accommodated. A converter cell without functional devices having a cell housing formed from a frame is also termed a flat-cell frame. The frame is preferably formed with the second polymer material, particularly preferentially completely of the second polymer material. This preferred design provides the advantage of being able to form each housing part without receiving spaces. In accordance with a preferred further development, two of said current conducting devices extend at least partially through the frame into the environment. In accordance with a further preferred further development, at least one of said housing parts comprises one or two of said pole contact sections.

The first and/or second housing part preferably comprises a first heat transfer region which is provided to exchange thermal energy with the electrode assembly. The first heat transfer region is preferably in substantially flat contact with the electrode assembly, particularly one of its surface areas. This preferred configuration provides the advantage of thermal energy being able to be supplied to or withdrawn from the electrode assembly.

The first and/or second housing part preferably comprises a second heat transfer region which is provided to exchange thermal energy with one of the tempering devices which are not a part of the converter cell. The second heat transfer region is preferably in substantially flat contact with said tempering device. This preferred configuration provides the advantage of the housing part being able to exchange thermal energy with the tempering device, particularly to or from the electrode assembly.

In accordance with one preferred configuration, at least one or two of said current conducting devices each comprise at least one contact section. Said contact section serves in particular the electrical connection to at least one or more of the functional devices, preferably the electrical supply of at least one or more of said functional devices. Preferably, at least one of said contact sections comprises a metal, particularly preferentially aluminum and/or copper.

The contact section is preferably arranged in an edge section of the first housing part, particularly in the area of the second polymer material. The second polymer material preferably leaves the contact section opposite at least one of said electrode connecting sections open. This configuration provides the advantage of the second polymer material contact section being held substantially immovable relative to the first housing part. This configuration provides the further advantage of the second polymer material being able to protect the electrical connection of the contact section to the electrode connecting section of the functional device from exposure to chemicals from the environment of the converter cell.

The contact section preferably extends in the direction of the functional device, in particular through one of its contact openings. The contact section is preferably designed as a contact projection. The contact section or contact projection respectively is preferably designed as a protuberance. The contact section, contact projection respectively, can preferably be produced in a forming process. This design provides the advantage of being able to readily automate the connection between the current conducting device and the functional device. This design provides the advantage of simplifying the forming of the contact section. This design provides the advantage of simplifying the manufacture of the operative electrical connection between the electrode assembly and the functional device.

The connection between the contact section and the electrode connecting section is preferably material, particularly preferentially by means of a friction welding or ultrasonic welding process. This design provides the advantage of being able to readily automate the connection between the current conducting device and the functional device.

One or two of said current conducting devices preferably comprises one or more of said collector tabs each, particularly in their second region, particularly in the interior of the cell housing. Said plurality of collector tabs are configured for the electrical, particularly material, connection to the same electrode of the electrode assembly configured as an electrode coil or to a plurality of electrodes of like polarity of the electrode assembly configured as an electrode stack. Said plurality of collector tabs are preferably electrically connected, particularly materially, to the same electrode of the electrode assembly configured as an electrode coil or to a plurality of electrodes of like polarity of the electrode assembly configured as an electrode stack.

In accordance with one preferred configuration, the current conducting device further comprises:
1. a substantially plate-shaped metallic or metal-coated current collector which is designed for electrically, particularly materially, connecting to at least one or more of said collector tabs, which extends into the interior of the cell housing, which particularly preferentially extends at least partially out of the cell housing into the environment of the converter cell, particularly for electrically connecting to a connection device which is not a part of the converter cell, which can be electrically insulated relative the first support element, or
2. a substantially plate-shaped metallic or metal-coated current collector which is designed for electrically, particularly materially, connecting to one of said functional devices, which extends at least partially out of the cell housing into the environment of the converter cell, particularly for electrically connecting to a connection device which is not a part of the converter cell, which can be electrically insulated relative the first support element, wherein the at least one collector tab can be electrically connected to the same functional device, particularly in a material connection, or
3. a substantially plate-shaped metallic or metal-coated current collector having a tab connecting section and a terminal connecting section, wherein the tab connecting section extends at least partially into the interior of the cell housing and is designed to electrically connect to the at least one collector tab, particularly in a material connection, wherein the terminal connecting section extends at least partially from the cell housing into the environment of the converter cell and is designed to electrically connect to a terminal connecting section which is not a part of the converter cell, particularly in a force-fit connection, wherein the terminal connecting section can be electrically insulated relative the first support element, wherein the tab connecting section and the terminal connecting section can be electrically, particularly materially, connected to the same functional device, wherein the tab connecting section and the terminal connecting section can be reversibly electrically interconnected by means of said functional device.

The current conducting device according to No. 1 has the advantage of improved mechanical stability as the collector tabs dampen transmission of mechanical vibrations to the electrode assembly during converter cell operation.

The current conducting device according to No. 2 has the advantage of improved mechanical stability as the collector tabs dampen transmission of mechanical vibrations to the electrode assembly during converter cell operation. The No. 2 current conducting device has the advantage of simplified configuration.

The current conducting device according to No. 3 has the advantage of improved mechanical stability as the collector tabs dampen transmission of mechanical vibrations to the electrode assembly during converter cell operation. The No. 3 current conducting device has the advantage of said cell current being able to be interrupted by means of the functional device.

The plurality of collector tabs of like polarity are preferably materially and electrically connected to the current collector, or its tab connecting section respectively, in a friction welding process. This preferred configuration has the advantage of slowing down the connection's aging.

The current collector is preferably connected to the first housing part, particularly at its edge section, particularly in a material connection. The current collector can preferably be electrically insulated vis-à-vis the first housing part, its first support element respectively. Particularly preferential is for the current collector to extend through the second polymer material in the edge section of the first housing part. Thus, the current collector can be materially connected, and in particular so as to gas-tight, to the first housing part in a first manufacturing step and the collector tabs materially connected, particularly bonded, to the current collector in a after manufacturing step.

In accordance with a first preferred embodiment of the current conducting device, the current collector also extends from the cell housing into the environment of the converter cell as well. One or more of said collector tabs of like polarity are preferably electrically connectable to the current collector within the cell housing, particularly in a material connection. The current collector is preferably configured as a metal plate, blanked part and/or sheet metal part. The current collector can preferably be electrically insulated vis-à-vis the first housing part, its first support element respectively. This preferred embodiment provides the advantage of lower manufacturing costs. This preferred embodiment provides the further advantage of a sufficiently mechanically stable design to the current conducting device in the first region, outside the cell housing respectively, particularly for connecting to a connector device which is not a part of the converter cell, for example a bus bar, a conductor lead or a connection cable.

In accordance with a second preferred embodiment of the current conducting device, the current collector is configured with a contact surface. One or more of said collector tabs of like polarity are electrically connectable to the current collector within the cell housing, particularly in a material connection. Said contact surface is arranged substantially in a surface area of one of said housing parts or extends only marginally into the environment. The contact section is preferably provided for the electrical connection to a spring-loaded connector device. The current collector can preferably be electrically insulated vis-à-vis the first housing part, its first support element respectively. This preferred embodiment provides the advantage of the contact surface being able to be covered by an insulating adhesive strip for the transport or storage of the converter cell.

In accordance with a third preferred embodiment of the current conducting device, the current collector is of two-piece configuration and comprises a substantially plate-shaped, metallic or metal-coated tab connecting section and likewise terminal connecting section. At least one or more of said collector tabs of like polarity are electrically connected to the tab connecting section within the cell housing, particularly in a material connection. The terminal connecting section extends out of the cell housing into the environment, in particular through the second polymer material, particularly to connect to one of said connector devices. Both the tab connecting section as well as the terminal connecting section are electrically connectable to the same functional devices, particularly in a material connection. The tab connecting section and/or the terminal connecting section preferably exhibit a respective projection which is electrically connectable, particularly materially, to the same said functional devices. The tab connecting section and the terminal connecting section are not electrically connectable to one another directly. The tab connecting section and the terminal connecting section are electrically connectable to one another via said functional device, preferably by means of a functional element designed as a semiconductor switch. This preferred embodiment has the advantage that by insulating the tab connecting section from the terminal connecting section, the cell current can be inhibited, in particular to stop a charge or discharge operation.

In accordance with a fourth preferred embodiment of the current conducting device, the current collector is only configured with said terminal connecting section according to the third preferred embodiment without said tab connecting section. In this embodiment, at least one or more of said collector tabs of like polarity is/are electrically connected, particularly materially, to one of said functional devices within the cell housing. The terminal connecting section extends from the cell housing into the environment, in particular through the second polymer material, particularly to connect to one of said connector devices. The terminal connecting section is electrically connected to the same of said functional devices as the at least one or more of said collector tabs. The terminal connecting section and the collector tabs of like polarity are not electrically connectable to one another directly. The terminal connecting section and the collector tabs of like polarity are electrically connectable to one another via said functional device, preferably by means of a functional element designed as a semiconductor switch. This preferred embodiment has the advantage that by insulating the terminal connecting section from the collector tabs of like polarity, the cell current can be inhibited, in particular to stop a charge or discharge operation. This preferred embodiment provides the advantage of a simplified structure to the current conducting device.

In accordance with a fifth preferred embodiment of the current conducting device, at least one or more of said collector tabs of like polarity is/are electrically connected, particularly materially, to one of said functional devices within the cell housing. Said functional device exhibits one of said pole contact sections. The pole contact section and the collector tabs of like polarity are not electrically connected to one another directly. Said pole contact section and said collector tabs of like polarity are electrically connectable to one another via said functional device, preferably by means of a functional element designed as a semiconductor switch. This preferred embodiment has the advantage that by insulating the terminal connecting section from the collector tabs of like polarity, the cell current can be inhibited, in particular to stop a charge or discharge operation. This preferred embodiment provides the advantage of a simplified structure to the current conducting device. This preferred embodiment provides the advantage of the pole contact section being able to be covered by an insulating adhesive strip for the transport or storage of the converter cell.

In accordance with one preferred configuration, the first support element comprises at least one or two of said pole contact openings which make one or two of said pole contact sections of the functional device accessible from the environment.

Preferably at least one of the functional devices, particularly in the area of the at least one pole contact opening, comprises at least one of said pole contact sections having the electric potential of one of the electrodes of the electrode assembly which preferably serves in electrically connecting said electrode to another converter cell or to a load. The functional device of one of said electrodes preferably comprises a connection area which is in particular faced toward the current conducting device, preferably its contact section.

An electrical connection is preferably formed between the current conducting device, its contact section in particular, and the functional device to enable the electrode assembly to be able to electrically supply the functional device or at least one of its functional elements respectively.

In accordance with one preferred further development of the first housing part, the first support element comprises two pole contact openings, the functional device two pole contact sections of different polarity, and the functional device two electrode connecting sections of different polarity. This further development has the advantage of the second housing part being able to be configured without a pole contact section, which reduces in particular the associated manufacturing costs.

A temperature sensor and/or thermocouple is preferably integrated into the second area of the current conducting device, particularly in its current collector. The input leads to the temperature sensor and/or thermocouple terminate in the edge section of the first housing part. Two connections to the functional device are also arranged in the area of said recess and electrically connected to the contact surfaces. This design provides the advantage of enabling temperature measurements in the current conducting device.

In accordance with one preferred configuration, the converter cell comprises a housing assembly with the first housing part and at least one or two of said current conducting devices of different polarity. Said housing assembly serves in particular in simplifying the manufacture of the converter cell. The first housing part exhibits a particularly laminar material bonding to the first support element and the at least one functional device. The first housing part further comprises the second polymer material, particularly in its edge section. The second polymer material preferably encloses an edge section of the first housing part, at least areas thereof. The first housing part further comprises the receiving space which is provided to at least partially accommodate the electrode assembly. The at least one of said current conducting devices, in particular the current collector, exhibits said contact section, which is arranged in the edge section of the first housing part, preferably in the second polymer material. The contact section is connected, particularly electrically, to the functional device, particularly to its electrode connecting section. This preferred configuration provides the advantage that the housing assembly can be readied separately.

The electrode assembly is not inserted into the receiving space until after the housing assembly is finished. This preferred configuration provides the further advantage that any thermal energy input during the forming of the receiving space, the arrangement of the second polymer material on the first housing part and/or in the particularly material connection of the current conducting device and first housing part during the manufacture of said housing assembly cannot lead to the heating up or accelerated aging of the electrode assembly.

In accordance with one preferred configuration, at least one of said functional devices, particularly the first housing part, comprises said cell control device, at least one or two of said electrode connecting sections and at least one or more of said sensors. The at least one sensor is provided to detect a converter cell operating parameter, particularly from its electrode assembly, and furnish it to the cell control device.

An operating parameter in the sense of the invention is to be understood as a parameter, in particular of the converter cell, which in particular
allows inferring the presence of a desired and/or predetermined operating state of the converter cell or its electrode assembly respectively, and/or
allows inferring the presence of an unplanned and/or unwanted operating state of the converter cell or its electrode assembly respectively, and/or
is preferably an electrical voltage or an electric current determinable by means of a detector element or sensor, wherein the sensor at least intermittently provides a signal which is proportional to the detected parameter, and/or
can be processed by a control device, a cell control device in particular, can be in particular compared to a target value, can in particular be linked to another detected parameter, and/or
enables indication of the cell voltage, the cell current; i.e. the intensity of the electrical current into or out of the electrode assembly, the cell temperature, the internal pressure of the converter cell, the integrity of the converter cell, the release of a substance from the electrode assembly, the presence of a foreign substance particularly from the environment of the converter cell and/or the state of charge, and/or
induces the conveying of the converter cell into another operating state.

The cell control device is provided to control at least one operational process of the converter cell, particularly the charging and/or discharging of the electrode assembly. The cell control device preferably monitors an operating state of the converter cell. The cell control device preferably initiates the conveying of the converting cell into a predetermined operating state. The cell control device preferably indicates the state of the converter cell by means of a display device, particularly by means of at least one LED. This preferred configuration has the advantage of the cell control device being disposed in the first housing part so as to be protected. This preferred configuration has the further advantage of the converter cell having its own cell control device for the operation and/or monitoring of the electrode assembly which also remains on the converter cell when the converter cell is extracted from a battery.

In accordance with one preferred configuration, the cell control device is provided to initiate the conveying of the converter cell into a “safe” state, wherein the converter cell charge in the safe state amounts to no more than half of the charge capacity, wherein the cell voltage particularly in the safe state amounts to a maximum of 3 V. This preferred configuration has the advantage of the converter cell also being able to be conveyed into the safe state when external of a battery pack.

In accordance with a first preferred further development, the functional device comprises a first short-range radio device signal-connected to the cell control unit.

Said first short-range radio device serves in particular in the wireless communication with a controlling battery control unit, particularly with its second short-range radio device. The first short-range radio device is preferably designed to transmit a predetermined signal to a controlling battery control unit, in particular periodically. This further development has the advantage of the battery control unit being able to incorporate the affiliated converter cell in the predetermined signal for supplying a load. This further development has the further advantage of the battery control unit being able to isolate a converter cell upon the absence of the predetermined signal.

In accordance with a further preferred further development, the functional device comprises two cell control connections and the first support element comprises two recesses in the area of said cell control connections. The cell control connections enable the converter cell to be connected to a data line and/or data bus. This preferred further development has the advantage of the cell control unit being able to communicate with the controlling battery control unit via the two cell control connections.

In accordance with one preferred configuration, the converter cell is designed to receive and/or discharge a charge of at least 3 ampere-hours [Ah], further preferentially of at least 5 Ah, further preferentially of at least 10 Ah, further preferentially of at least 20 Ah, further preferentially of at least 50 Ah, further preferentially of at least 100 Ah, further preferentially of at least 200 Ah, further preferentially of at most 500 Ah. This configuration provides the advantage of increasing the service life of the load which the converter cell supplies.

In accordance with one preferred configuration, the converter cell is designed to provide a current of at least 50 A, further preferentially of at least 100 A, further preferentially of at least 200 A, further preferentially of at least 500 A, further preferentially of at most 1000 A, particularly for at least one hour. This configuration provides the advantage of improving the performance of the load which the converter cell supplies.

In accordance with one preferred configuration, the converter cell is designed to provide an electrical voltage, a terminal voltage in particular, of at least 1.2 V, further preferentially of at least 1.5 V, further preferentially of at least 2 V, further preferentially of at least 2.5 V, further preferentially of at least 3 V, further preferentially of at least 3.5 V, further preferentially of at least 4 V, further preferentially of at least 4.5 V, further preferentially of at least 5 V, further preferentially of at least 5.5 V, further preferentially of at least 6 V, further preferentially of at least 6.5 V, further preferentially of at least 7 V, further preferentially of at most 7.5 V, particularly for at least one hour. The electrode assembly preferably comprises lithium ions. This configuration provides the advantage of increasing the converter cell's energy density.

In accordance with one preferred configuration, the converter cell is operable within a temperature range of between −40° C. and 100° C., further preferentially of between −20° C. and 80° C., further preferentially of between −10° C. and 60° C., further preferentially of between 0° C. and 40° C., particularly for at least one hour. This configuration provides the advantage of the most unlimited possible positioning or use respectively of the converter cell to supply a load, particularly a motor vehicle or a stationary system and/or mechanism.

In accordance with one preferred configuration, the converter cell comprises a gravimetric energy density of at least 50 Wh/kg, further preferentially of at least 100 Wh/kg, further preferentially of at least 200 Wh/kg, further preferentially of less than 500 Wh/kg. The electrode assembly preferably comprises lithium ions. This configuration provides the advantage of increasing the converter cell's energy density.

In accordance with one preferred configuration, the converter cell is provided for installation into a vehicle having at least one electric motor. The converter cell is preferably provided to supply said electric motor. The converter cell is provided particularly preferentially to at least intermittently supply an electric motor for a drive train of a hybrid or electric vehicle. This embodiment provides the advantage of improving the electric motor supply.

In accordance with a further preferred configuration, the converter cell is provided for use in a stationary battery, particularly a buffer memory, as a device battery, an industrial battery or a starter battery. The charging capacity of the converter cell for these applications preferably amounts to at least 50 Ah. This embodiment provides the advantage of improving the supplying of a stationary load, particularly a stationary mounted electric motor.

In accordance with a preferred configuration, the at least one separator, which is not or only a poor conductor of electrons, is composed of a substrate which is at least partially permeable to material. The substrate is preferably coated on at least one side with an inorganic material. An organic material preferably formed as a non-woven fibrous web is preferably employed as the at least partially material-permeable substrate. The organic material, which preferably contains a polymer and particularly preferentially a polyethylene terephthalate (PET), is coated with an inorganic, preferably ion-conductive material, which is further preferably conductive to ions in a temperature range of from −40° C. to 200° C. The inorganic material preferentially contains at least one compound from among the group of oxides, phosphates, sulfates, titanates, silicates and aluminosilicates having at least one of the elements of Zr, Al, Li, particularly preferentially zircon oxide. Zircon oxide in particular serves in the separator's material integrity, nanoporosity and flexibility. The inorganic, ion-conductive material preferentially has a diameter of no larger than 100 nm. This embodiment has the advantage of improving the stability of the electrode assembly at temperatures above 100° C. The Evonik AG company markets an example of such a separator in Germany under the trade name of “Separion”.

In accordance with a second preferred embodiment, the at least one separator, which is not or only a poor conductor of electrons, but is conductive to ions, is at least predominantly or wholly composed of a ceramic, preferably an oxide ceramic. This embodiment has the advantage of improving the stability of the electrode assembly at temperatures above 100° C.

In accordance with one preferred configuration, a battery comprises at least two inventive converter cells or their preferred embodiments. The battery further comprises a battery control unit and preferably a second short-range radio device. The second short-range radio device is preferably connected to one of said first short-range radio devices of one of said converter cells by means of signals.

It is particularly preferential for the second short-range radio device to be provided to intermittently send a predetermined first signal, whereupon a first of said short-range radio devices responds with a predetermined signal. This design provides the advantage of the second short-range radio device being able to poll the functioning of the battery's converter cells.

It is particularly preferential for the battery control unit to be provided such that after the second short-range radio device receives a predetermined second signal from one of said first short-range radio devices of one of the converter cells, it can integrate said converter cell into the supply of a connected load. This configuration provides the advantage of simplifying the replacement of a converter cell.

### Preferred Converter Cell Embodiments

A first preferred embodiment of the converter cell comprises said electrode assembly, a first and second of said current conducting devices of different polarity and said cell housing. The electrode assembly is designed as a particularly rechargeable flat-pack type electrode coil, particularly a rechargeable electrode stack or converter assembly having at least one electrode each of a first and second polarity.

The current conducting devices exhibit at least one or more of said collector tabs, wherein each current conducting device electrically connects the at least one collector tab to the current collector in the cell housing. The first current conducting device, particularly its collector tab, is electrically connected to the electrode of first polarity. The second current conducting device, particularly its collector tab, is electrically connected to the electrode of second polarity. Said current conducting devices each further comprise one of said current collectors which preferably extend into the environment of the converter cell, particularly for the simplified electrical connection to a connector device. The collector tabs and the current collector of at least one of said current conducting devices are connected, particularly in a material connection.

The cell housing exhibits said first housing part. The first housing part comprises the first support element and at least one or more of said functional devices, each with at least one or more of said functional elements. The first support element is configured with a metal sheet. The first support element limits the at least one of said functional devices relative the environment of the converter cell. The at least one functional device is arranged between the first support element and the electrode assembly. The first support element is connected to at least areas of at least one of said functional devices, particularly in a material connection. The first housing part comprises the second polymer material at its edge section, said material preferably enclosing the edge section of the first housing part. The current collector of at least the first current conducting device is led through the second polymer material, preferably electrically insulated vis-à-vis the first support element. The current collector of the second current conducting device is preferably led through the second polymer material, preferably electrically insulated vis-à-vis the first support element. The second polymer material preferably connects in material and/or gas-tight manner the edge section of the first housing part and the current collector of the first current conducting device, preferably also the current collector of the second current conducting device. The first housing part preferably exhibits a receiving space which at least partially accommodates the electrode assembly.

The first housing part preferably exhibits one of said separator elements. Said separator element is of flat configuration and arranged between the functional device and the electrode assembly. The separator element is connected to the functional device, particularly in a material connection. The separator element serves in electrically insulating the electrode assembly from the functional device and is in particular configured with a polymer material.

The at least one functional device is operatively connected, particular electrically, to the electrode assembly. The at least one functional device comprises one, preferably two, of said electrode connecting sections which serve the electrical connection to the electrode assembly. Both current conducting devices exhibit a respective contact section, wherein the contact sections serve in the electrical connection to the at least one functional device, particularly via its electrode connecting section. The first electrode connecting section of the at least one functional device and the contact section of the first current conducting device are connected to one another electrically, preferably in a material connection. The second electrode connecting section of the at least one functional device is preferably electrically connected to the contact section of the second current conducting device, preferably in a material connection. The at least one functional device is preferably configured with a circuit carrier, wherein the circuit carrier is in particular configured as a populated, particularly flexible circuit board. Particularly preferential is for the functional device to exhibit said cell control device.

The cell housing further comprises a second housing part. The second housing part comprises at least the first support element, wherein the first support element of the second housing part is configured with a particularly fiber-interspersed first polymer material and/or with a metal sheet. Together with the first housing part, the second housing part forms the cell housing around the electrode assembly. The second housing part preferably exhibits the second polymer material in an edge section, which particularly preferentially encloses said edge section of the second housing part. The current collector of the second current conducting device is preferably led through the second polymer material. The second polymer material preferably connects the edge section of the second housing part and the current collector of the second current conducting device in a material and/or gas-tight connection. The second housing part preferably exhibits a receiving space which at least partially accommodates the electrode assembly.

One of said first or second housing parts preferably exhibits one of said first and/or second heat transfer areas. The housing part is thus able to exchange thermal energy with the electrode assembly, particularly to dissipate heat from the electrode assembly.

The cell housing preferably encloses the electrode assembly such that frictional force between the cell housing and the electrode assembly counters their unwanted relative motion.

This preferred embodiment provides the advantages of
the first support element protecting the functional device from harmful influences from the environment of the converter cell,
countering harmful consequences for the functional device from vibrations during operation,
the functional device being held substantially immovable in the cell housing,
the functional device remaining on the converter cell, particularly in the event of an accident,
the cell control device controlling or monitoring the functions of the converter cell, particularly of its electrode assembly, also independently of a battery control unit, particularly when the converter cell is not part of a battery,
being able to prevent the accelerated aging of the electrode assembly by dissipating thermal energy from the electrode assembly via one of said housing parts.

In accordance with a first preferred further development of the present preferred embodiment, the current collector of the first current conducting device is led through the second polymer material of the first housing part and the current collector of the second current conducting device is led through the second polymer material of the second housing part. This further development has the advantage of the first and the second housing parts being able to be manufactured in several identical manufacturing steps, thereby reducing the manufacturing expenditure.

In accordance with a second preferred further development of the present preferred embodiment, both current collectors are led through the second polymer material of the first housing part. The receiving space of the first housing part is further dimensioned so as to substantially accommodate the entire electrode assembly. This further development has the advantage that the second housing part can remain substantially without a receiving space, which thereby reduces the associated manufacturing expenditure. This further development provides the further advantage of simplifying the electrical connection of the collector tabs and current collectors after the electrode assembly has been inserted into the receiving space, particularly due to improved accessibility.

In deviation from the first preferred embodiment, the first housing part and the second housing part are connected together by means of a hinge section in a second preferred embodiment. The hinge section extends along one limiting edge of the first housing part and the second housing part respectively. The hinge section preferably exhibits a smaller wall thickness than the area of the housing parts limiting the electrode assembly. It is particularly preferential for the hinge section to be configured as a film hinge. This preferred embodiment has the advan-tage of reducing the length of the cell housing edges to be sealed. This preferred further development can be combined with the first or second preferred further development.

In deviation from the first preferred embodiment, the first housing part and the second housing part are distanced from one another by means of a frame in a third preferred embodiment. The housing parts are connected to the frame, particularly in a material connection. The frame essentially exhibits four frame elements arranged relative one another so as to correspond to a rectangle. The frame defines a space provided for receiving the electrode assembly. The frame is preferably configured with the second polymer material, particularly preferentially configured substantially completely from the second polymer material. This preferred embodiment has the advantage that at least one of the housing parts can be configured without said receiving space. In accordance with a preferred further development, two of said current conducting devices extend through the frame at least partially into the environment. In accordance with a further preferred further development, at least one of said housing parts comprises one or two of said pole contact sections.

The first housing part preferably comprises one of said separator elements. Said separator element is of flat configuration and arranged between the functional device and the electrode assembly. The separator element is connected to the functional device, particularly in a material connection. The separator element serves in electrically insulating the electrode assembly from the functional device and is in particular configured with a polymer material.

This preferred embodiment provides the advantages of
the first support element protecting the functional device from harmful influences from the environment of the converter cell,
countering harmful consequences for the functional device from vibrations during operation,
the functional device being held substantially immovable in the cell housing,
the functional device remaining on the converter cell, particularly in the event of an accident,
the cell control device controlling or monitoring the functions of the converter cell, particularly of its electrode assembly, also independently of a battery control unit, particularly when the converter cell is not part of a battery,
being able to prevent the accelerated aging of the electrode assembly by dissipating thermal energy from the electrode assembly via one of said housing parts.

In deviation from one of the first, second or third preferred embodiments, the electrode assembly are configured as a converter assembly in a fourth preferred embodiment of the converter cell. At least one of said functional devices of this preferred embodiment comprises at least one, preferably two or three of said fluid passages. A fluid feed line which is not a part of the converter cell is connected to said fluid passage which in particular serves in the supply or extraction of one of said process fluids. Said fluid passage is preferably of substantially tubular configuration and materially and/or gas-tight connected to the first base layer. It is particularly preferential for said fluid passage to extend from the cell housing into the environment of the converter cell.

The first housing part preferably comprises one of said separator elements. Said separator element is of flat configuration and arranged between the functional device and the converter assembly. The separator element is connected to the functional device, particularly in a material connection. The separator element serves in electrically insulating the converter assembly from the functional device and is in particular configured with a polymer material.

In accordance with a first preferred further development of the present preferred embodiment, the converter assembly is configured as a polymer electrolyte fuel cell. The membrane is conductive to protons. H₂ serves as fuel and is supplied to the negative electrode provided with a noble metal catalyst, particularly Pt. After ionization, the protons travel through the membrane to the positive electrode to there meet the oxidizing agent. Water is produced as an educt.

In accordance with a second preferred further development of the present preferred embodiment, the converter assembly is characterized by the integrating of a hydrogen reservoir and a miniaturized fuel cell into one unit. Doing so thus does away with the need for any peripheral components such as pressure reducers, pressure regulators or hydrogen feed lines. The hydrogen is supplied to the fuel cell directly from the integrated reservoir. The volume of hydrogen supplied to the fuel cell is regulated by the material properties of the hydrogen reservoir's surface as well as by the contact surface between the hydrogen reservoir and the fuel cell. In order to realize the fuel cell entirely without active components, it is designed as a self-breathing system. This preferred further development offers considerable potential for miniaturization.

In accordance with a third preferred further development of the present preferred embodiment, the converter assembly is designed with an air cathode of highly porous Al₂O₃, ZnO or SiC. The anode is of compressed Zn powder, metal foam with intercalated Zn, or ceramic, particularly SiC, with Zn matter. The electrolyte and separator are configured as fibrous material or porous ceramic with 30% KOH. This preferred further development is particularly suitable for high operating temperatures.

In deviation from the first, second or third preferred embodiments, one of the housing parts in a fifth preferred embodiment of the converter cell is configured to be of substantially bowl shape having a receiving space and an access opening to said receiving space. The other of the housing parts is substantially configured as a cover for said access opening, particularly as a cover module for closing said access opening. The at least one functional device is preferably connected to the bowl-shaped housing part, particularly in a material connection. Alternatively, the at least one functional device is connected to the cover or cover module, particularly in a material connection. The bowl-shaped housing part preferably receives the electrode assembly such that the first support element also exerts a nominal force on a surface area of the electrode assembly.

The first housing part preferably comprises one of said separator elements. Said separator element is of flat configuration and arranged between the functional device and the electrode assembly. The separator element is connected to the functional device, particularly in a material connection. The separator element serves in electrically insulating the electrode assembly from the functional device and is in particular configured with a polymer material.

The present preferred configuration has the advantage of improving the cohesion of the electrode assembly. This preferred design provides the advantage of improving the thermal contact between a temperature sensor of the functional device and one of the surface areas of the electrode assembly.

A sixth preferred embodiment of the converter cell corresponds substantially to the first or second preferred embodiment, whereby, however, one or two of said current conducting devices are configured in accordance with No. 2, wherein one or more of said collector tabs are electrically connected to one of said functional devices, or in accordance with No. 3, wherein the current collector is of two-part design with said tab connecting section and said terminal connecting section.

The first housing part preferably comprises one of said separator elements. Said separator element is of flat configuration and arranged between the functional device and the electrode assembly. The separator element is connected to the functional device, particularly in a material connection. The separator element serves in electrically insulating the electrode assembly from the functional device and is in particular configured with a polymer material.

The present preferred configuration provides the advantage of the functional device being able to interrupt the cell current.

In accordance with a preferential further development of the present preferred embodiment, at least one semiconductor switch of said functional device, preferably a field-effect transistor, is connected between the tab connecting section and the terminal connecting section. Said semiconductor switch is controllable by the cell control device. The tab connecting section and the terminal connecting section are configured as metal plates. Areas of the functional device are preferably configured to be electrically insulating and arranged between the tab connecting section and the terminal connecting section. The tab connecting section and/or the terminal connecting section preferably exhibit(s) a recess for at least the semiconductor switch. The semiconductor switch is preferably in flat contact with the tab connecting section and/or the terminal connecting section for improved thermal conduction. This preferred further development provides the advantage of the functional device being able to contain the cell current. This preferred further development provides the advantage of reducing the expenditure involved in cooling the semiconductor switch.

### Method of Manufacturing a Converter Cell or Modules of Same

A first manufacturing method, particularly for manufacturing one of said first or second housing parts, is characterized by the following steps:
S1 joining a plurality of said functional elements, particularly functional elements in accordance with the first preferred configuration of the functional device, thereby forming a functional assembly, preferably having a circuit carrier, in particular a flexible circuit carrier,
S2 furnishing the first support element, preferably from a second supply, same preferably comprising one of said receiving spaces which preferably comprises one or two of said pole contact openings,
S3 placing the at least one of said functional devices or functional assemblies particularly in accordance with step S1, preferably from the first supply, on the first support element, particularly in its receiving space, particularly after step S2,
S4 connecting, particularly in a material connection, the first support element having at least one of said functional devices and/or functional assemblies particularly in accordance with step S1, preferably under the influence of heat, to preferably a first polymer material, preferably by means of a said isotactic or continuous press, thereby forming the first or second housing part, particularly after step S3, preferably comprising
S5 forming one of said receiving spaces for the electrode assembly in the first support element, in particular prior to step S2, particularly after step S4, particularly in a forming tool, particularly by deforming with a body adapted to the receiving space which preferably corresponds substantially to the form of the electrode assembly, wherein the receiving space is particularly preferentially produced by closing the forming tool, and/or
S6 placing one of said separator elements on the functional device and/or functional assembly, in particular materially connecting the separator element to the functional device and/or functional assembly, particularly after step S3 or S4.

This manufacturing method has the advantage of
the cell housing and/or its first housing part being able to be manufactured at a predetermined flexural rigidity and/or a predetermined energy consumption capacity relative a foreign body acting on the converter cell from the environment, thereby improving in particular the converter cell's mechanical stability, and/or
the first support element improving the cohesion of the functional device, whereby the converter cell's stability relative vibrations is improved or the functioning of the converter cell when subject to vibrations is improved respectively, and/or
being able to dispense with separate, reinforcing components, particularly in contrast to converter cells with foil-like cell housings, and/or
simplifying the later manufacturing steps after the forming of the functional device and/or the first housing part, thereby reducing manufacturing costs, and/or
improving manufacturing yield and quality, and/or
countering an inadvertent loss of the functional device from the connecting of the functional device, or functional assembly respectively, and the first support element to the housing part, and/or
the metallic first support element improving the protection of the functional device, and/or
the respective housing part being able to be adapted to the dimensions of the electrode assembly by means of the receiving space exhibiting different forms, in particular different depths.

A second manufacturing method, particularly for manufacturing an above-cited housing assembly, is characterized by the following steps:
S11 furnishing one of said first housing parts, manufactured in particular in accordance with the first manufacturing method, particularly in a machining device, particularly a forming tool,
S12 inserting at least one or more of said current collectors or terminal connecting sections into the machining device, in particular into said forming tool, in particular to the first housing part, particularly after step S11,
S13 connecting, particularly materially, the at least one current collector or the at least one terminal connecting section to the first housing part, particularly after step S12, thereby preferably electrically insulating the at least one current collector or the at least one terminal connecting section vis-à-vis the first housing part, preferably
S14 supplying a particularly flowable second polymer material, wherein said second polymer material is disposed in the edge section of the first housing part, particularly at a working temperature which corresponds at least to the softening point of said second polymer material,
   preferably under the influence of heat and preferably at a pressure difference to the ambient air pressure to the first housing part in the machining device,
   wherein preferably a respective one of said contact sections of at least one or two of said current conducting devices remains free, wherein preferably S14 occurs concurrently with S12 or S13.

A pressure difference to the environment of the machining device in step 14 is to be understood in terms of the invention as the second polymer material having a higher static pressure upon being supplied to the machining device than the static pressure within said machining device.

In accordance with a preferred configuration of step S14, the second polymer material is exposed to high pressure relative the environment of the machining device. In accordance with a further preferred configuration of step S14, a low pressure relative the machining device environment prevails in the area of the housing parts inserted into the machining device. Both pressure differences serve in improving the supplying of the second polymer material into the machining device. Both configurations provide the advantage of improving the filling of the area of the machining device provided for the second polymer material when connecting the inserted housing parts.

One or two of said current collectors or terminal connecting sections are materially connected to the first housing part, particularly in gas-tight manner, by the second polymer material, preferably during step S14.

This manufacturing method has the advantage of
the housing assembly simplifying the further manufacture of the converter cell, and/or
improving the stability of the converter cell, particularly due to step 14.

A third manufacturing method, particularly for manufacturing an above-cited housing assembly, is characterized by the following steps:
S17 furnishing one of said first housing parts, manufactured in particular in accordance with the first manufacturing method, or the housing assembly, manufactured in particular in accordance with the second manufacturing method, preferably in a machining device which serves particularly in forming the cell housing around the electrode assembly,
S19 supplying the electrode assembly which comprises at least one or more of said collector tabs to the first housing part or the housing assembly, particularly in the machining device, preferably inserting the electrode assembly into the receiving space of the first housing part or the housing assembly, particularly after step S17,
S20 electrically, particularly materially, connecting at least one or more of said collector tabs to at least one of said current collectors or to one of said functional devices or to one of said tab connecting sections, particularly by means of a bonding process, preferably by means of a friction welding process, particularly preferentially by means of ultrasonic welding, particularly after step S17 or S19,
S23 supplying the second housing part to the first housing part or to the housing assembly, particularly in the machining device, wherein the second housing part preferably exhibits the second polymer material in an edge section, particularly after step S20,
S26 connecting, particularly materially, the second housing part to the first housing part or to the housing assembly, particularly at a working temperature which at least corresponds to the softening point of the second polymer material, wherein an edge section of the first housing part or housing assembly is preferably connected to the second housing part, wherein the second polymer material is preferably configured as an adhesive or sealant, particularly after step S23,
   preferably comprising
S21 supplying a formed part, configured in particular as a frame, formed with the second polymer material and at least one of said current collectors or at least one of said terminal connecting sections respectively, in particular prior to step S 23, and/or
S25 heating the edge section of the first housing part, the second housing part and/or the housing assembly to a working temperature which corresponds to at least the softening point of the second polymer material, preferably simultaneously with step S 26.

This manufacturing method has the advantage of
the cell housing and/or its first housing part being able to be manufactured at a predetermined flexural rigidity and/or a predetermined energy consumption capacity relative a foreign body acting on the converter cell from the environment, thereby improving in particular the converter cell's mechanical stability, and/or
the first support element improving the cohesion of the functional device, whereby the stability of the converter cell relative vibrations and/or the functioning of the converter cell when subject to vibrations is improved, and/or
being able to dispense with separate, reinforcing components, particularly in contrast to converter cells with foil-like cell housings, and/or
simplifying the later manufacturing steps after the forming of the functional device and/or the first housing part, thereby reducing manufacturing costs, and/or
improving manufacturing yield and quality, and/or
countering an inadvertent loss of the functional device from the connecting of the functional device, or functional assembly respectively, and the first support element to the housing part, and/or
the metallic first support element improving the protection of the functional device.

Further advantages, features and possible applications of the present invention will ensue from the following description in conjunction with the figures which show:

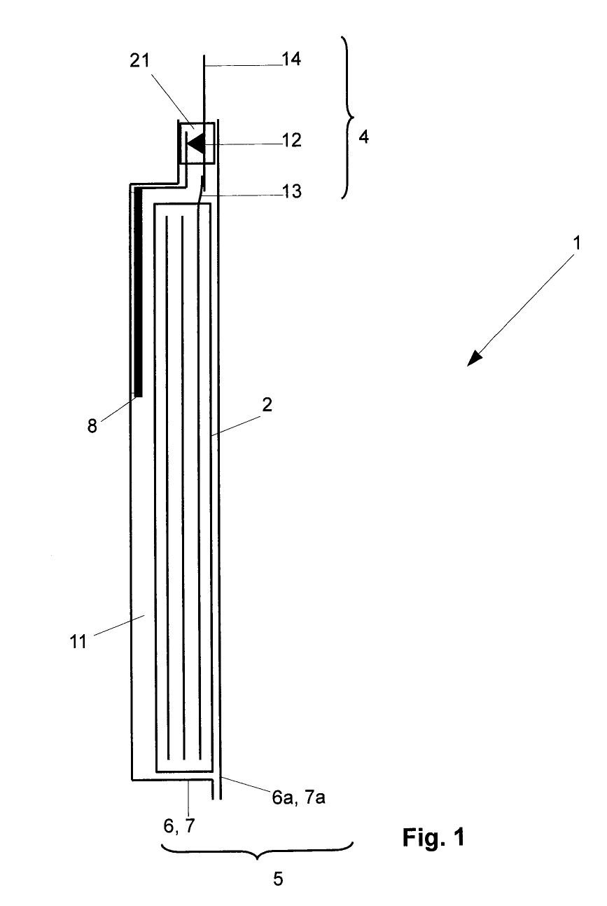

FIG. 1 a schematic view of a preferred configuration of the converter cell,

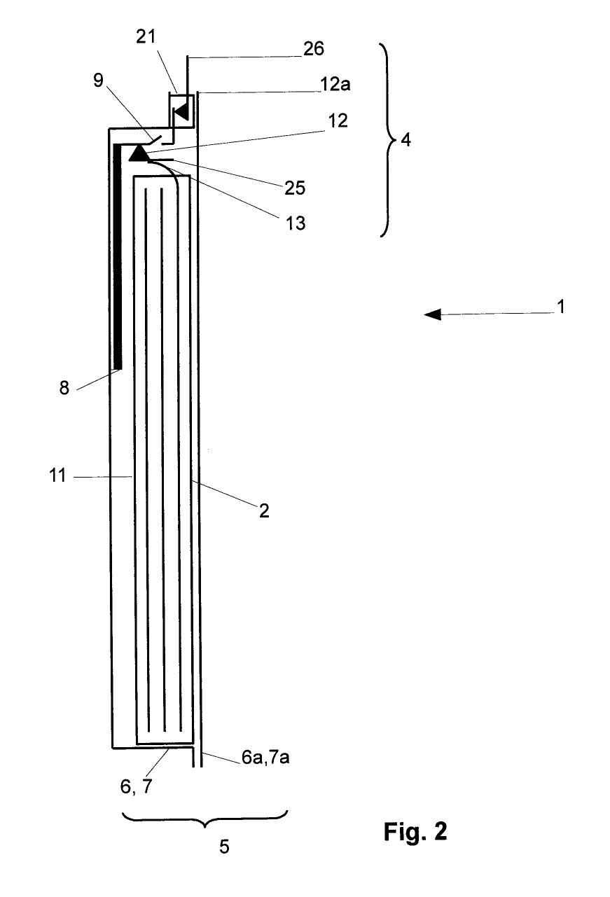

FIG. 2 a schematic view of a further preferred configuration of the converter cell,

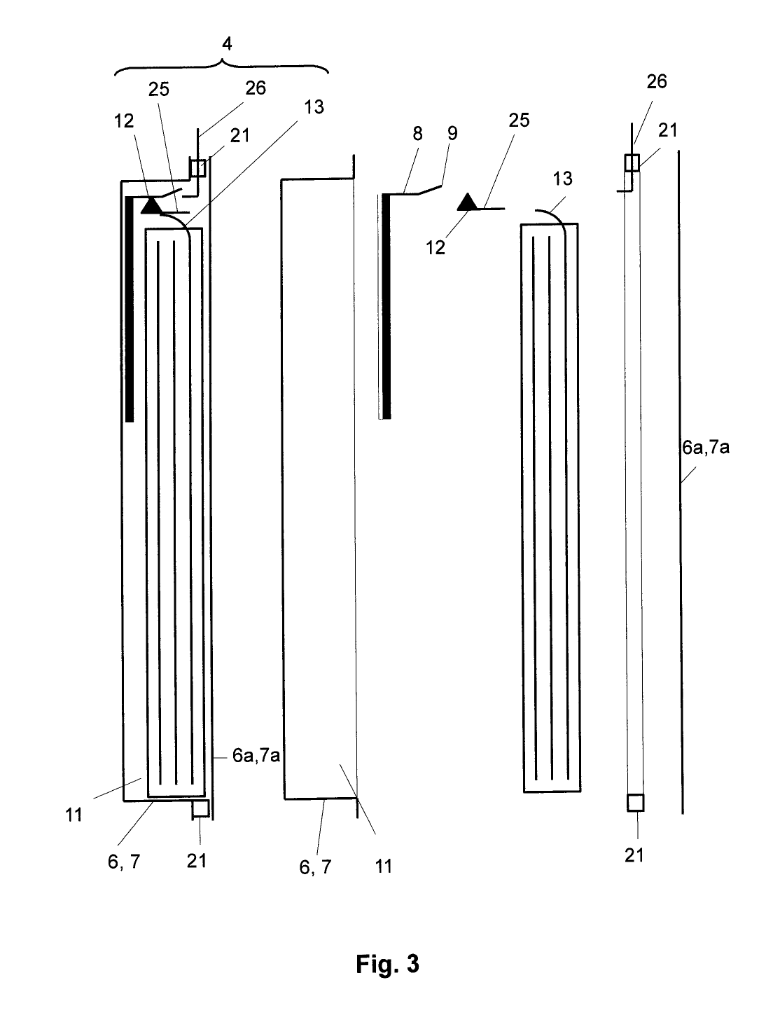

FIG. 3 a schematic view of a further preferred configuration of the converter cell, also broken down into different modules,

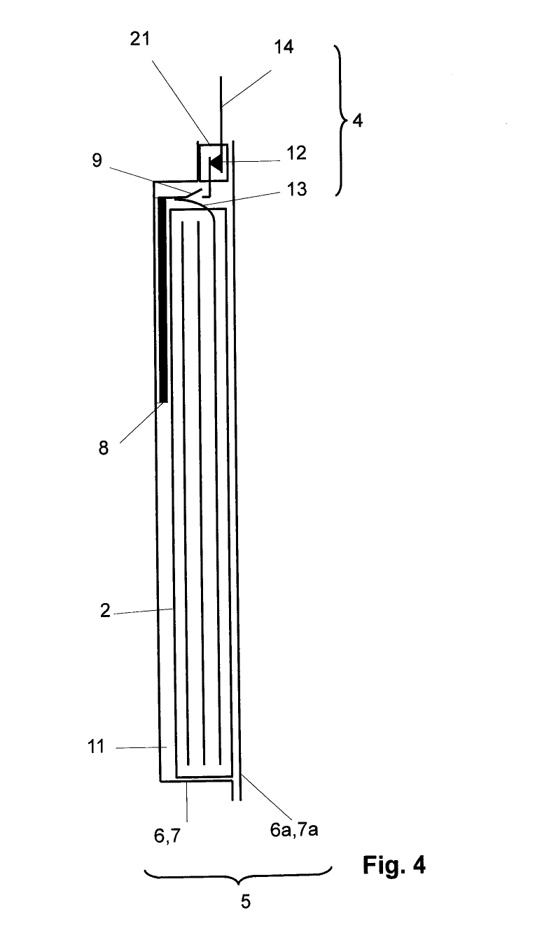

FIG. 4 a schematic view of a further preferred configuration of the converter cell,

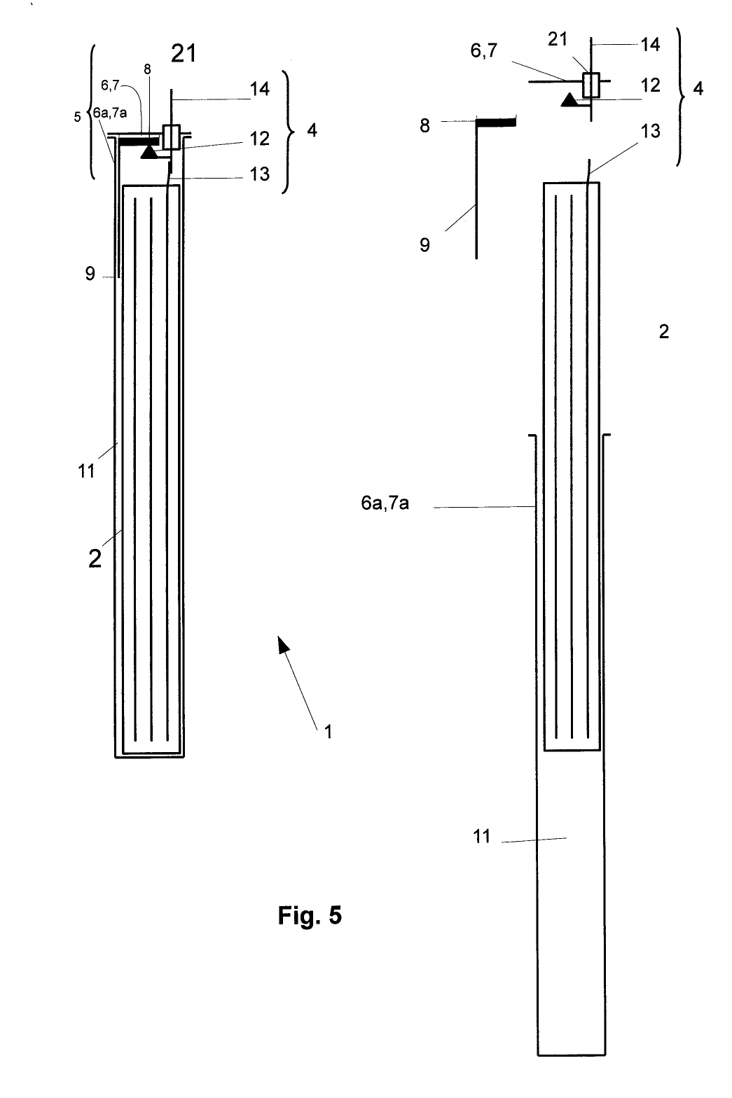

FIG. 5 a schematic view of a further preferred configuration of the converter cell, also broken down into different modules,

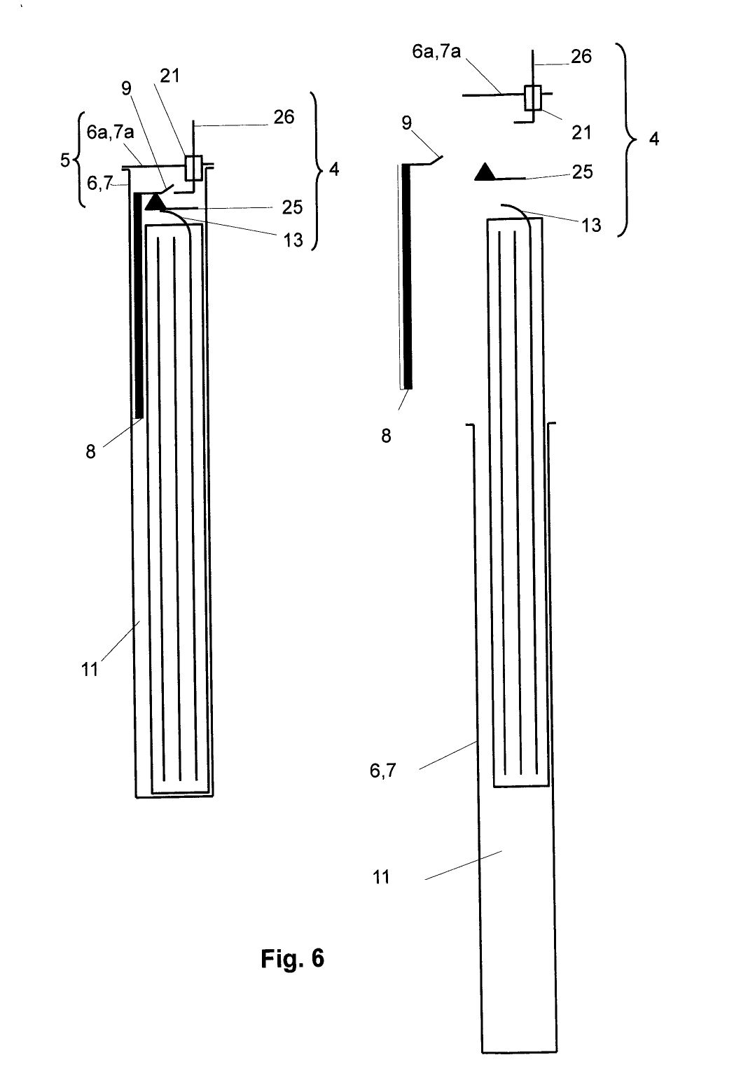

FIG. 6 a schematic view of a further preferred configuration of the converter cell, also broken down into different modules,

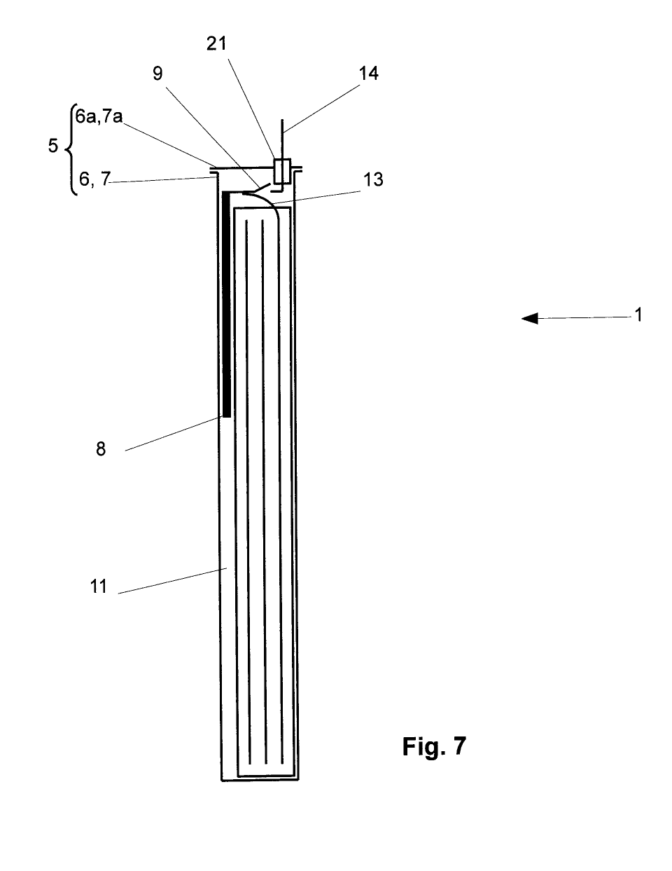

FIG. 7 a schematic view of a further preferred configuration of the converter cell,

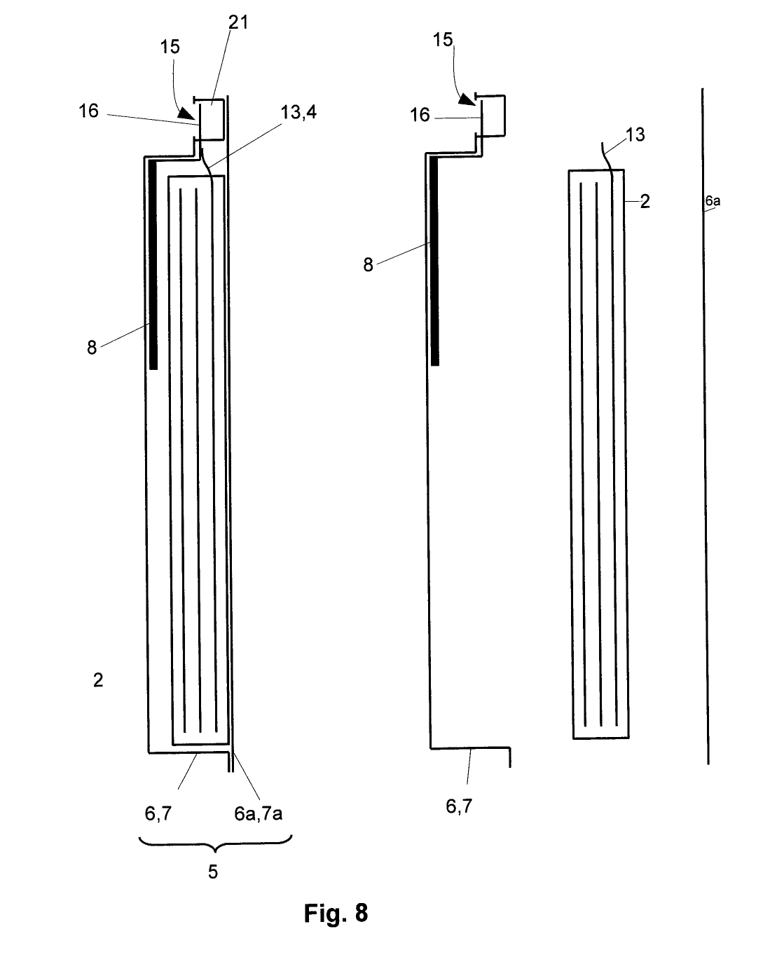

FIG. 8 a schematic view of a further preferred configuration of the converter cell, also broken down into different modules,

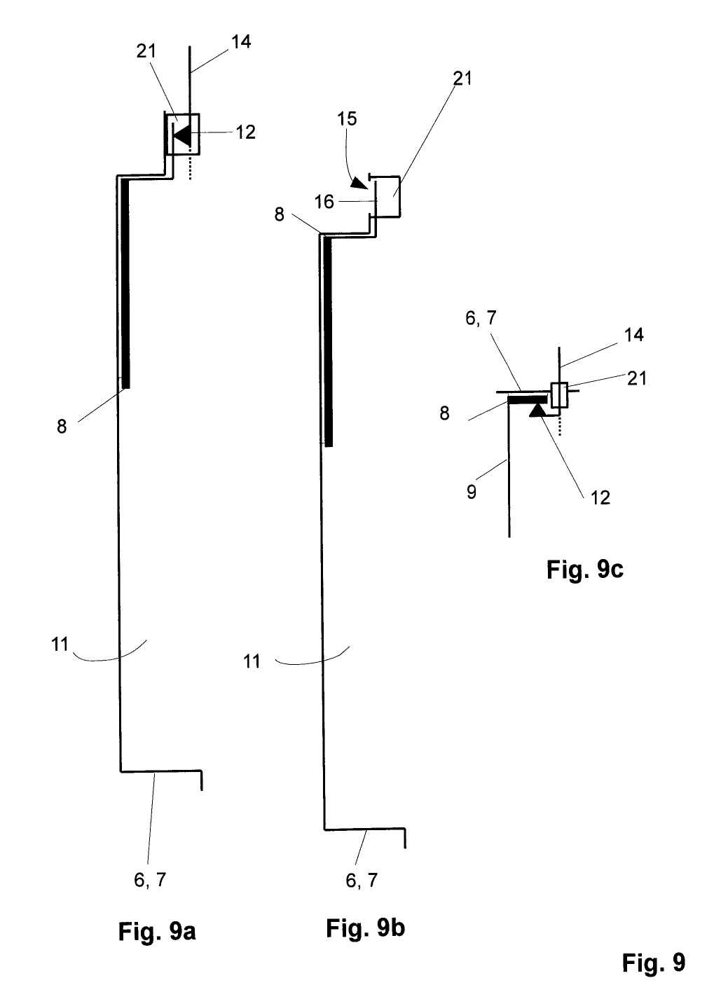

FIG. 9 a schematic view of different modules for preferred converter cell configurations,

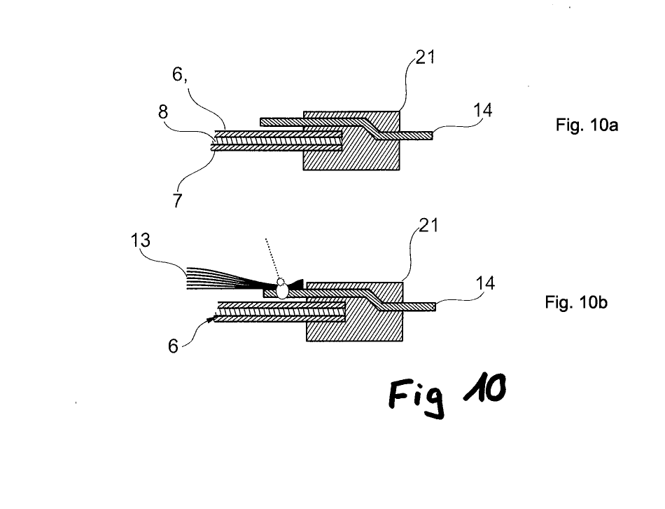

FIG. 10 schematic details of a preferred configuration of the converter cell,

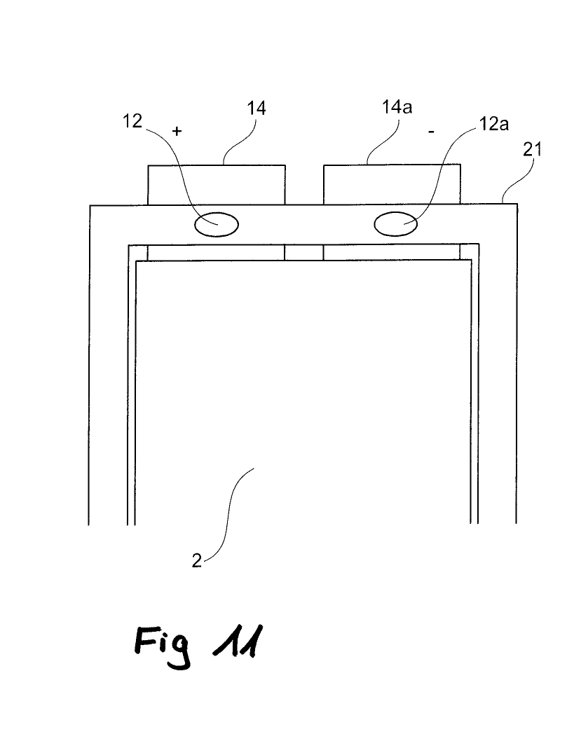

FIG. 11 further schematic details of a preferred configuration of the converter cell,

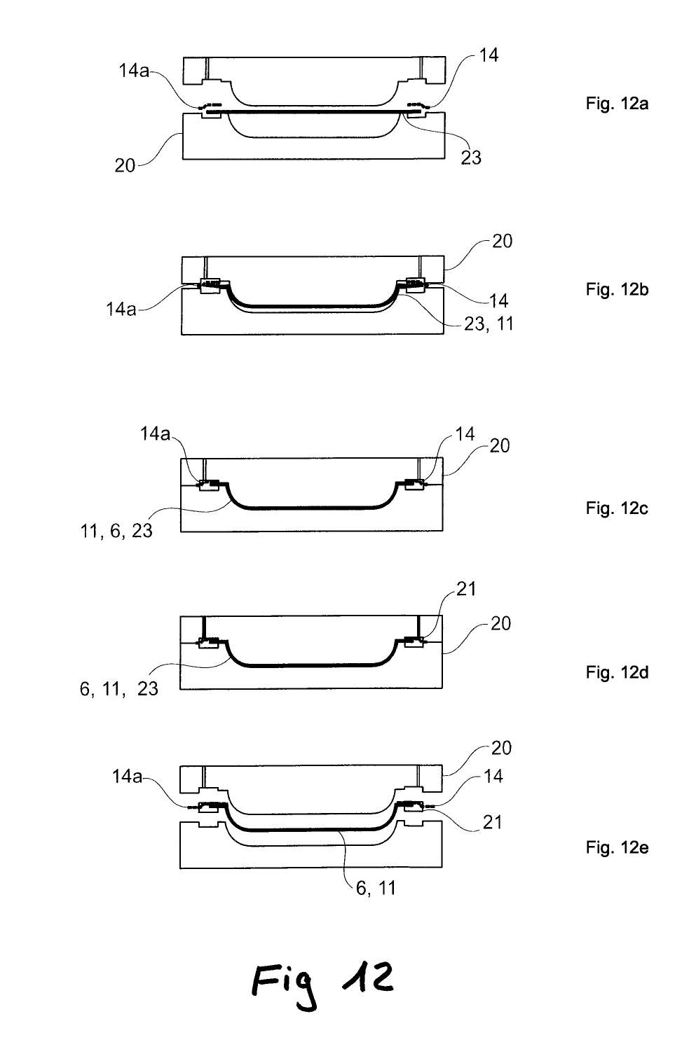

FIG. 12 a schematic view of a succession of steps in the manufacturing of a so-called housing assembly,

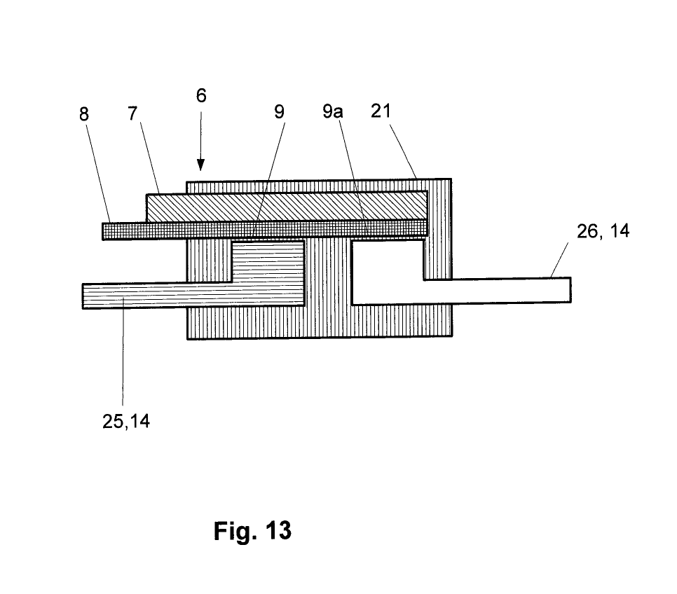

FIG. 13 schematic details of a preferred configuration of the converter cell.

FIG. 1 schematically shows a preferential configuration of a converter cell 1 having a first housing part 6, a second housing part 6a, which together form the cell housing 5, an electrode assembly 2 and a current conducting device 4. The second current conducting device is not shown.

The first housing part 6 comprises a first support element 7 and a functional device 8 designed as a functional assembly having a circuit carrier. The functional device 8 is materially connected to the first support element 7, in the present case bonded. The functional device 8 is electrically insulated vis-à-vis the first support element 7. The first housing part 6 exhibits a receiving space 11 for the electrode assembly 2.

The current conducting device 4 comprises collector tabs 13, whereby only one collector tab is depicted. The current conducting device 4 further comprises a current collector 14 which extends into the environment of the converter cell 1. The current conducting device 4, its current collector 14 in particular, comprises a contact section 12, configured here as a contact projection. The electrode assembly 2 is electrically connected to the functional device 8 by means of said contact projection 12, particularly for electrically supplying the functional device 8.

By means of these electrical connections between the current conducting devices and the functional device, the functional device is able to detect the terminal voltage as well as the cell current of the electrode stack.

The second polymer material 21 is disposed between the first housing part 6 and the second housing part 6a. The second polymer material 21 materially connects, particularly in gas-tight manner, the current collector 14, the contact projection 12 and a section of the functional device 8. The second polymer material 21 further connects sections of the first housing part 6 to the second housing part 6a.

FIG. 2 schematically shows a further preferential configuration of the converter cell 1. The current conducting device 4 depicted here deviates from its FIG. 1 preferential configuration depiction. The differences from the FIG. 1 configuration will be defined in the following.

The current conducting device 4 also comprises: collector tabs 13, a tab connecting section 25, two contact projections 12, 12a, a terminal connecting section 26.

The current conducting device 4 is in sections formed integrally with the functional device 8, wherein this section of the functional device 8 thereby serves to electrically connect the tab connecting section 25 to the terminal connecting section 26 so as to be separable, particularly by means of the functional element 9, designed here as a controlled switching device.

The collector tabs 13, whereby only one collector tab is depicted, are electrically connected to the tab connecting section 25, particularly in a material connection. The tab connecting section 25 comprises the contact projection 12. The contact projection 12 is electrically connected to the functional device 8, particularly in a material connection.

The terminal connecting section 26 comprises this contact projection 12a. The contact projection 12a is electrically connected to the functional device 8, particularly in a material connection. A section of the functional device 8, the contact projection 12a and a section of the terminal connecting section 26 are materially connected to the second polymer material 21, in particular enclosed in gas-tight manner.

In all other respects, the FIG. 1 description also applies here.

FIG. 3 schematically shows a further preferential configuration of converter cell 1, also broken down into different modules. The current conducting device 4 as well as the second polymer material 21 depicted here deviates from their FIG. 2 preferential configuration depiction. The differences from the FIG. 2 configuration will be defined in the following.

The second polymer material 21 is configured as a frame and can be materially connected to the edges of the first housing part 6 and the second housing part 6a.

The terminal connecting section 26 extends through the second polymer material 21. The second polymer material 21 encloses the terminal connecting section 26 in gas-tight manner.

The current conducting device 4 also comprises: collector tabs 13, a tab connecting section 25, a contact projection 12, a terminal connecting section 26.

The current conducting device 4 is in sections formed integrally with the functional device 8, wherein said section of the functional device 8 thereby serves to electrically connect the tab connecting section 25 to the terminal connecting section 26 so as to be separable, particularly by means of the functional element 9, designed here as a controlled switching device.

In all other respects, the FIG. 1 description also applies here.

FIG. 4 schematically shows a further preferential configuration of converter cell 1. The current conducting device 4 depicted here deviates from its FIG. 2 preferential configuration depiction. The differences from the FIG. 2 configuration will be defined in the following.

The current conducting device 4 also comprises: collector tabs 13, a contact projection 12 and a current collector 14. The collector tabs 13 are electrically connected to the functional device 8, particularly in a material connection.

The current conducting device 4 is in sections formed integrally with the functional device 8, wherein said section of the functional device 8 thereby serves to electrically connect the collector tabs 13 to the current collector 14, particularly by means of the functional element 9, designed here as a controlled switching device.

In all other respects, the FIG. 1 description also applies here.

FIG. 5 schematically shows a further preferential configuration of converter cell 1, also broken down into different modules. The cell housing is applicably formed from a first housing part 6 and a second housing part 6a. The converter cell 1 further comprises an electrode assembly 2 and a current conducting device 4. The second current conducting device is not shown.

The first housing part 6 comprises the first support element 7 and the functional device 8. The functional device 8 comprises a thermocouple 9. The first support element 7 and the functional device 8 are materially connected, in particular bonded. The functional device 8 is electrically insulated vis-à-vis the first support element 7. The first housing part 6 is designed as a cover and serves to close the second housing part 6a, in particular to close receiving space 11.

The second housing part 6a is of bowl-shaped configuration and comprises the receiving space 11. The electrode assembly 2 is arranged in receiving space 11.

The thermocouple 9 extends between the electrode assembly 2 and the second housing part 6a. When the electrode assembly 2 is inserted, the second housing part 6a exerts a force on the thermocouple 9 and the electrode assembly 2. This force serves in particular to counter an unwanted relative motion between the electrode assembly 2 and the second housing part 6a. This force serves in particular in improving the thermal contact between the thermocouple 2 and the electrode assembly 2.

The current conducting device 4 comprises collector tabs 13, whereby only one collector tab is depicted. The current conducting device 4 further comprises a current collector 14 which extends into the environment of the converter cell 1. The current conducting device 4, particularly its current collector 14, comprises a contact section 12, configured here as a contact projection. The electrode assembly 2 is electrically connected to the functional device 8 by means of said contact projection 12, particularly for the electrical supplying of the functional device 8.

By means of these electrical connections between the current conducting devices and the functional device, the functional device is able to detect the terminal voltage as well as the cell current of the electrode stack.

The first housing part 6 exhibits the second polymer material 21 in an edge section. The second polymer material 21 connects the first housing part 6 to the current collector 14, particularly in a material connection. The second polymer material 21 encloses the current collector 14, particularly in gas-tight manner.

FIG. 6 schematically shows a further preferential configuration of converter cell 1, also broken down into different modules. The current conducting device 4 depicted here deviates from its FIG. 5 preferential configuration depiction. The differences from the FIG. 5 configuration will be defined in the following.

The current conducting device 4 also comprises: collector tabs 13, a tab connecting section 25, a contact projection 12 and a terminal connecting section 26.

The current conducting device 4 is in sections formed integrally with the functional device 8, wherein said section of the functional device 8 thereby serves to electrically connect the tab connecting section 25 to the terminal connecting section 26 so as to be separable, particularly by means of the functional element 9, designed here as a controlled switching device.

The collector tabs 13, whereby only one collector tab is depicted, are electrically connected to the tab connecting section 25, particularly in a material connection. The tab connecting section 25 comprises the contact projection 12. The contact projection 12 is electrically connected to the functional device 8, particularly in a material connection.

In this preferential configuration, the functional device 8 is materially connected to the bowl-shaped first housing part 6. The second housing part 6a is configured here as a cover.

The second housing part 6a exhibits the second polymer material 21 in an edge section. The second polymer material 21 connects the first housing part 6 to the terminal connecting section 26, particularly in a material connection. The second polymer material 21 encloses the terminal connecting section 26, particularly in gas-tight manner.

In all other respects, the FIG. 5 description also applies here.

FIG. 7 schematically shows a further preferential configuration of converter cell 1. The current conducting device 4 depicted here deviates from its FIG. 5 preferential configuration depiction. The differences from the FIG. 5 configuration will be defined in the following.

The current conducting device 4 also comprises: collector tabs 13, whereby only one collector tab is depicted, and a current collector 14. The collector tabs 13 are electrically connected to the functional device 8, particularly in a material connection. The current collector 14 also extends into the environment of the converter cell 1.

The current conducting device 4 is in sections formed integrally with the functional device 8, wherein said section of the functional device 8 thereby serves to electrically connect the collector tabs 13 to the current collector 14 so as to be separable, particularly by means of the functional element 9, designed here as a controlled switching device.

The second polymer material 21 materially connects the current collector 14 to the second housing part 6a.

In all other respects, the FIG. 5 description also applies here.

FIG. 8 schematically shows a further preferential configuration of converter cell 1, having a first housing part 6, a second housing part 6a, which together form the cell housing 5, an electrode assembly 2 and a current conducting device 4. The second current conducting device is not shown.

The first housing part 6 comprises a first support element 7 and a functional device 8 designed as a functional assembly having a circuit carrier. The functional device 8 is materially connected to the first support element 7, in the present case bonded. The first housing part 6 exhibits a receiving space 11 for the electrode assembly 2.

The current conducting device 4 comprises collector tabs 13, whereby only one collector tab is depicted. The collector tabs 13 are electrically connected to the functional device 8, preferably in a material connection. Hence, the electrode assembly 2 is electrically connected to the functional device 8, particularly for electrically supplying the functional device 8.

By means of these electrical connections between the current conducting devices and the functional device, the functional device is able to detect the terminal voltage as well as the cell current of the electrode stack.

In this preferential configuration, the first housing part 8 comprises a pole contact opening 15 and the functional device 8 a pole contact section 16. The pole contact opening 15 enables the pole contact section 16 to be electrically accessed or contacted from the environment of the converter cell 1.

The functional device 8 is materially connected to the first housing part 6 in the area of the pole contact opening 15, particularly so as to be gas-tight, by means of the second polymer material 21.

FIG. 9 schematically shows different housing assemblies for preferred configurations of the converter cell.

Common to said housing assemblies is: the first housing part 6 having a first support element 7 and a functional device 8. The functional device 8 is materially connected to the first support element 7. The functional device 8 is electrically insulated vis-à-vis the first support element 7. The second polymer material 21 is disposed in an edge section of the first housing part.

In the housing assemblies according to FIGS. 9a and 9b, the first housing part 6 comprises the receiving space 11.

In FIG. 9a, a current collector 14 comprising a contact projection 12 is electrically connected to the functional device 8 within the second polymer material 21, particularly in a material connection. This housing assembly can thus be designed such that not-shown collector tabs can be electrically connected to the current collector 14 or to the functional device 8, particularly in a material connection.

In FIG. 9b, the first support element 7 comprises a pole contact opening 15. The functional device 8 comprises a pole contact section 8 in the region of said pole contact opening 15 to electrically contact the not-shown electrode assembly. The second polymer material 21 holds the pole contact section 16 in the region of said pole contact opening 15.

In FIG. 9c, the first housing part 6 exhibits a recess for the lead-in of the current collector 14. The second polymer material 21 holds the current collector 14 in the region of said recess. The current collector 14 comprises a contact projection 12. The first housing part 6 is configured as a cover and without a receiving space. The functional device 8 comprises a thermocouple 9. The functional device 8 is materially connected to the first support element 7. The functional device 8 is electrically insulated vis-à-vis the first support element 7. This housing assembly can thus be designed such that not-shown collector tabs can be electrically connected to the current collector 14 or to the functional device 8, particularly in a material connection.

FIG. 10 shows schematic details of a preferred configuration of the converter cell.

FIG. 10a shows that the first housing part 6 is insert-molded into an edge section with a second polymer material 21. A current collector 14 is in particular injection-molded from the second polymer material 21 so as to be gas-tight and connected to the first housing part 6 so as to particularly be substantially immovable. The first housing part 6 comprises the first support element 7 and a functional device 8, wherein the functional device 8 is connected to the first support element 7, particularly in a material connection.

FIG. 10b shows that the collector tabs 13 are connected, in particular welded, to the current collector 14. The collector tabs 13 are also connected to the first-polarity electrodes of a not-shown electrode assembly, particularly in a material connection. This electrical connection is established after the not-shown electrode assembly is inserted into the first housing part 6 and before the cell housing is closed.

FIG. 11 schematically shows further details of a preferential configuration of the converter cell.

An electrode assembly 2 is inserted into a first housing part or its receiving space respectively and electrically connected to current collectors 14, 14a. Collector tabs which serve the electrical connection between a current collector 14, 14a and a respective electrode of the electrode assembly 2 are not shown. Both current collectors 14, 14a comprise contact sections 12, 12a. Of the first housing part, only the second polymer material 21 is depicted. The support elements and functional devices are not depicted so that the contact sections 12, 12a can be more easily recognized. The contact sections 12, 12a extend from the second polymer material 21 toward the not-shown functional device. The contact sections 12, 12a serve the electrical connection, particularly the electrical supply of the not-shown functional device.

FIG. 12 schematically shows a succession of steps in the manufacturing of a so-called housing assembly. The functional device is not shown.

FIG. 12a shows a housing part blank 23 as well as current collectors 14, 14a which are inserted into the machining device, configured here as forming tool 20. The two-piece forming tool is not yet closed. One part of the forming tool 20 is formed with a recess, the other part of the forming tool 20 with a projection. The recess and projection serve in forming a receiving space in the housing part blank 23 or the first housing part respectively for the not-shown electrode assembly.

FIG. 12b shows the forming tool 20 during the closing process, whereby the receiving space 11 is formed in the housing part blank 23 by means of the recess and the projection.

FIG. 12c shows the closed forming tool 20. After plastic deformation, the inserted housing part blank 23 exhibits the receiving space 11. The current collectors 14, 14a are held in predetermined positions relative the housing part blank 23 in the forming tool 20, particularly in the edge section of the housing part blank 23. The housing part blank 23 preferably has a working temperature which at least corresponds to the softening point of the second polymer material, in particular so that the housing part blank 23 can thereby enter into a tight material connection with the not-shown second polymer material.

FIG. 12d shows the closed forming tool 20 as well as the inserted housing part blank 23 according to FIG. 10 at a later point in time. Heated second polymer material 21 is fed into the forming tool 20 through two channels. The second polymer material 21 fills in cavities provided in the forming tool 20 arranged in the edge sections of the housing part blank 23. The current collectors 14, 14a also extend through the cavities. The edge sections of the housing part blank 23 as well as the current collectors 14, 14a are insert-molded upon the feeding in of the second polymer material 21. The housing part blank 23 preferably has a working temperature which at least corresponds to the softening point of the first polymer material, in particular so that the housing part blank 23 can thereby enter into a tight material connection with the second polymer material 21.

After the second polymer material 21 has been supplied, its temperature, and particularly also the temperature of the housing part blank 23, is lowered so as to also fall below the softening temperature of the first polymer material. The housing assembly is thus thereby formed and ready to be withdrawn.

FIG. 12e shows the opened forming tool 20 as well as the ejected first housing part 6. The housing assembly comprises the first support element, at least one of said functional devices, the second polymer material 21 in the edge section, the receiving space 11 as well as the current collectors 14, 14a. After withdrawing the housing assembly, the forming tool 20 is ready to produce the next housing assembly.

FIG. 13 schematically shows details of a preferred configuration of the converter cell. Depicted is a sectional view through a first housing part 6 having a two-part current collector 14 in accordance with a preferred embodiment of the converter cell.

The two-part current collector 14 comprises the tab connecting section 25 for the electrical connection to not-shown collector tabs. The two-part current collector 14 further comprises the terminal connecting section 26 for the electrical connection to a not-shown connector device which is not a part of the converter cell, for example a power cable or bus bar. The second polymer material 21 is disposed in the edge section of the first housing part 6. The second polymer material 21 encloses the two-part current collector 14, the first support element 7 and the functional device 8 in gas-tight and/or material manner.

The functional device 8 comprises an electrode connecting section 9 as well as a contact connecting area 9a. One respective projection of the tab connecting section 25, the terminal connecting section 26 respectively, extends to the electrode connecting section 9, the contact connecting area 9a respectively.

Non-depicted parts of the functional device 8 are: a current limiter, a current sensor, a cell control device, a plurality of conductive paths, a thermocouple and preferably a first short-range radio device. The cell control device is provided to limit, control or regulate the cell current during charging and/or discharging of the converter cell, the electrode assembly respectively, by means of the current sensor, the current limiter, the thermocouple and preferably the first short-range radio device, preferably to prevent unwanted high electrode assembly temperatures.

### REFERENCE NUMERALS

1 converter cell
2 electrode assembly, converter assembly
3, 3a electrode
4, 4a current conducting device cell housing
6, 6a, 6b housing part
7, 7a support element
8, 8a, 8b functional device
9, 9a functional element
11, 11a receiving space
12, 12a contact section, contact projection
13 collector tab
14, 14a current collector
15, 15a pole contact opening
16, 16a pole contact section
17, 17a contact opening
19 supply
20 machining device, forming tool
21 second polymer material, frame of second polymer material
23 housing part blank
25 tab connecting section of current collector
26 terminal connecting section of current collector

1-13. (canceled)

14. A converter cell, in particular designed as an electrochemical energy converting device, comprising:
a rechargeable electrode assembly provided to at least intermittently supply electrical energy which exhibits at least two electrodes of different polarity;
a current conducting device, which is provided to electrically connect to one of the at least two electrodes of the electrode assembly; and
a cell housing including a first housing part, wherein the cell housing is configured to enclose at least sections of the electrode assembly, and wherein the first housing part includes
at least one functional device provided to support the release of energy from the electrode assembly, particularly to a load, which is operatively connected to the electrode assembly, particularly for receiving energy, and
a first support element which is provided to support the at least one functional device, wherein the first support element is formed with a metal sheet.

15. The converter cell according to claim 14, wherein at least one of said current conducting devices comprises at least one collector tab designed to connect to one of the electrodes of the electrode assembly, particularly in a material connection, particularly within the cell housing.

16. The converter cell according to claim 14, wherein the at least one functional device comprises at least one functional element, wherein the at least one functional element is operatively connected to the electrode assembly, particularly electrically connected.

17. The converter cell according to claim 14, wherein the cell housing includes a second housing part, wherein the second housing part
is configured to be at least sectionally connected to the first housing part, particularly in a material connection, and
is configured to form the cell housing of the converter cell together with the first housing part.

18. The converter cell according to claim 14, wherein the first housing part and/or the second housing part
comprises a receiving space which is provided to at least partially accommodate the electrode assembly, and/or
comprises a second polymer material in an edge section, wherein the second polymer material serves in the particularly material connection to another of said housing parts.

19. The converter cell according to claim 14, wherein the at least one current collector exhibits a contact section, wherein the contact section
serves the electrical contact of the functional device, and/or
is arranged in an edge section of the first housing part or second housing part, and/or
extends in the direction of the functional device, particularly configured as a contact projection.

20. The converter cell according to claim 14, wherein
one of said first support elements comprises at least one pole contact opening which particularly makes one section of the adjacent functional device accessible, particularly electrically, from the environment of the converter cell,
at least one of said functional devices, particularly in the section of the at least one pole contact opening comprises at least one of said pole contact sections having the potential of one of the electrodes of the electrode assembly,
the functional device comprises at least one of said electrode connecting sections which is in particular faced toward the current conducting device, and
an electrical connection is formed between the current collector device, particularly its contact section, and the functional device to enable the electrode assembly to be able to electrically supply the functional device or at least one of its functional elements respectively.

21. The converter cell according to claim 14, comprising a housing assembly including the first housing part and at least one of said current conducting devices which are connectable to said electrodes, particular of different polarity, wherein
the first support element is electrically insulated vis-à-vis the at least one functional device and said at least one current conducting device,
the first housing part comprises a second polymer material in its edge section,
the at least one functional device extends as far as into the edge section,
the first housing part comprises a receiving space, wherein the receiving space is provided to at least partially accommodate the electrode assembly,
at least one of said current collectors comprises one of said contact sections,
the contact section is electrically connected to the functional device, particularly to its electrode connecting section.

22. The converter cell according to claim 14, wherein
said cell control device which is configured to control at least one operational process of the converter cell, particularly the charging and/or discharging of the electrode assembly, and
one of said sensors which is designed to detect an operating parameter of the converter cell, particularly of the electrode assembly and furnish same to the cell control device.

23. A secondary battery comprising:
at least two converter cells according to claim 14;
a battery control unit.

24. A method of manufacturing said first or second housing part of the converter cell according to claim 17, comprising the steps of:
S1 joining a plurality of said functional elements, thereby forming a functional assembly,
S2 furnishing the first support element,
S3 placing the at least one of said functional devices or functional assemblies, particularly in accordance with step S1, on the first support element, particularly in its receiving space, in particular after step S2,
S4 connecting, particularly in a material connection, the first support element having at least one of said functional devices and/or functional assemblies, particularly in accordance with step S1, thereby forming the first or second housing part, particularly after step S3.

25. A method of manufacturing a housing assembly according to claim 8, comprising:
S11 furnishing one of said first housing parts, manufactured in particular in accordance with claim 11, particularly in a machining device, particularly a forming tool,
S12 inserting at least one or more of said current collectors or terminal connecting sections, into the machining device, in particular into said forming tool, in particular to the first housing part, particularly after step S11, and
S13 connecting, particularly materially, the at least one current collector or the at least one terminal connecting section to the first housing part, particularly after step S12.

26. A method for manufacturing a converter cell comprising:
S17 furnishing one of the first housing parts according to claim 14,
S19 supplying the electrode assembly which comprises at least one or more of said collector tabs to the first housing part or the housing assembly, particularly in the machining device,
S20 electrically, particularly materially, connecting at least one or more of said collector tabs, to at least one of said current collectors or to one of said functional devices or to one of said tab connecting sections, particularly by means of a bonding process,
S23 supplying the second housing part to the first housing part or to the housing assembly, particularly in the machining device, and
S26 connecting, particularly materially, the second housing part to the first housing part or to the housing assembly, particularly at a working temperature which at least corresponds to the softening point of the second polymer material.
